(19) United States
(12) Patent Application Publication
(10) Pub. No.: US 2022/0061021 A1
(43) Pub. Date: Feb. 24, 2022

(54) PAGING OVER SIDELINK VIA A RELAY USER EQUIPMENT

(71) Applicant: QUALCOMM Incorporated, San Diego, CA (US)

(72) Inventors: Kaidong WANG, San Diego, CA (US); Jelena DAMNJANOVIC, Del Mar, CA (US); Yan ZHOU, San Diego, CA (US); Ozcan OZTURK, San Diego, CA (US); Sony AKKARAKARAN, Poway, CA (US); Tao LUO, San Diego, CA (US)

(21) Appl. No.: 17/407,082

(22) Filed: Aug. 19, 2021

Related U.S. Application Data
(60) Provisional application No. 63/068,171, filed on Aug. 20, 2020.

(51) Int. Cl. H04W 68/00; H04W 72/04; H04L 1/00

(52) U.S. Cl. CPC H04W 68/005; H04W 72/042; H04W 92/18; H04L 1/0061; H04W 72/0466

(57) ABSTRACT

A method, apparatus, and computer-readable medium for wireless communication are provided. A second user equipment (UE) receives a paging message for a first UE from a base station while in a radio resource control (RRC) idle mode or an RRC inactive mode and transmits the paging message from the second UE to the first UE over sidelink. A method, apparatus, and computer-readable medium for wireless communication at a base station are provided. The base station determines to page a first UE in an inactive state or an idle state and transmits a paging message for the first UE to a second UE in a radio resource control (RRC) idle mode or an RRC inactive mode, the paging message to be relayed to the first UE over sidelink.

### CROSS REFERENCE TO RELATED APPLICATION(S)

This application claims the benefit of and priority to U.S. Provisional Application Ser. No. 63/068,171, entitled “Paging Over Sidelink via a Relay User Equipment” and filed on Aug. 20, 2020, which is expressly incorporated by reference herein in its entirety.

### INTRODUCTION

The present disclosure relates generally to communication systems, and more particularly, to wireless communication including paging.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some wireless communication may be communicated directly between wireless devices based on sidelink. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication is provided. The method includes receiving, at a second user equipment (UE), a paging message for a first UE from a base station while in a radio resource control (RRC) idle mode or an RRC inactive mode; and transmitting the paging message from the second UE to the first UE over sidelink.

In another aspect an apparatus for wireless communication is provided. The apparatus includes a memory and at least one processor, the memory and at least one processor are configured to receive, at a second UE, a paging message for a first UE from a base station while in an RRC idle mode or an RRC inactive mode; and transmit the paging message from the second UE to the first UE over sidelink.

In another aspect an apparatus for wireless communication is provided. The apparatus includes means for receiving, at a second UE, a paging message for a first UE from a base station while in an RRC idle mode or an RRC inactive mode; and means for transmitting the paging message from the second UE to the first UE over sidelink.

In another aspect, a computer-readable medium storing computer executable code is provided. The computer-readable medium may be non-transitory, for example. The code when executed by a processor cause the processor to receive, at a second UE, a paging message for a first UE from a base station while in an RRC idle mode or an RRC inactive mode; and transmit the paging message from the second UE to the first UE over sidelink.

In an aspect of the disclosure, a method of wireless communication at a base station is provided. The method includes determining to page a first UE in an inactive state or an idle state; and transmitting a paging message for the first UE to a second UE in an RRC idle mode or an RRC inactive mode, the paging message to be relayed to the first UE over sidelink.

In another aspect an apparatus for wireless communication at a base station is provided. The apparatus includes a memory and at least one processor, the memory and at least one processor are configured to determine to page a first UE in an inactive state or an idle state; and transmit a paging message for the first UE to a second UE in an RRC idle mode or an RRC inactive mode, the paging message to be relayed to the first UE over sidelink.

In another aspect an apparatus for wireless communication at a base station is provided. The apparatus includes means for determining to page a first UE in an inactive state or an idle state; and means for transmitting a paging message for the first UE to a second UE in an RRC idle mode or an RRC inactive mode, the paging message to be relayed to the first UE over sidelink

In another aspect, a computer-readable medium storing computer executable code is provided. The computer-readable medium may be non-transitory, for example. The code when executed by a processor cause the processor to determine to page a first UE in an inactive state or an idle state; and transmit a paging message for the first UE to a second UE in an RRC idle mode or an RRC inactive mode, the paging message to be relayed to the first UE over sidelink.

In another aspect of the disclosure, a method of wireless communication at a second UE is provided. The method includes receiving a paging message for a first UE from a base station; and transmitting the paging message from the second UE to the first UE over sidelink.

In another aspect an apparatus for wireless communication at a second UE is provided. The apparatus includes a memory and at least one processor, the memory and at least one processor are configured to receive a paging message for a first UE from a base station; and transmit the paging message from the second UE to the first UE over sidelink.

In another aspect an apparatus for wireless communication at a second UE is provided. The apparatus includes means for receiving a paging message for a first UE from a base station; and means for transmitting the paging message from the second UE to the first UE over sidelink.

In another aspect, a computer-readable medium storing computer executable code is provided. The computer-readable medium may be non-transitory, for example. The code when executed by a processor cause the processor to receive a paging message for a first UE from a base station; and transmit the paging message from the second UE to the first UE over sidelink.

In an aspect of the disclosure, a method of wireless communication at a base station is provided. The method includes determining to page a first UE in an inactive state or an idle state; and transmitting a paging message for the first UE to a second UE to be relayed to the first UE over sidelink.

In another aspect an apparatus for wireless communication at a base station is provided. The apparatus includes a memory and at least one processor, the memory and at least one processor are configured to determine to page a first UE in an inactive state or an idle state; and transmit a paging message for the first UE to a second UE to be relayed to the first UE over sidelink.

In another aspect an apparatus for wireless communication at a base station is provided. The apparatus includes means for determining to page a first UE in an inactive state or an idle state; and means for transmitting a paging message for the first UE to a second UE to be relayed to the first UE over sidelink

In another aspect, a computer-readable medium storing computer executable code is provided. The computer-readable medium may be non-transitory, for example. The code when executed by a processor cause the processor to determine to page a first UE in an inactive state or an idle state; and transmit a paging message for the first UE to a second UE to be relayed to the first UE over sidelink.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates an example communication flow for paging a base station to page a UE.

FIG. 5 illustrates an example of a serving base station initiating paging of a UE by target base stations.

FIG. 6A and FIG. 6B illustrate examples of paging a UE to provide a system information modification.

FIG. 7 illustrates an example of a communication system including UEs in coverage of a base station and out of coverage of the base station.

FIG. 8 illustrates examples of paging a target UE via a relay UE.

FIG. 9 illustrates examples of paging occasions configured for groups of UE.

FIG. 10 illustrates a communication flow for paging a target UE via a relay UE.

FIG. 11 illustrates a communication flow for paging a target UE via a relay UE.

FIG. 12 illustrates example aspects of a paging message to a relay UE.

FIG. 13 illustrates example aspects of a paging message to a relay UE.

FIG. 14 illustrates a communication flow for paging a target UE via a relay UE.

FIG. 15 illustrates example aspects of a paging message to a relay UE.

FIG. 16 is a flowchart of a method of wireless communication for relaying paging information from a base station to a target UE.

FIG. 17 is a flowchart of a method of wireless communication for relaying paging information from a base station to a target UE.

FIG. 18 is a diagram illustrating an example of a hardware implementation for an example apparatus.

FIG. 19 is a flowchart of a method of wireless communication to page a target UE via a relay UE.

FIG. 20 is a flowchart of a method of wireless communication to page a target UE via a relay UE.

FIG. 21 is a diagram illustrating an example of a hardware implementation for an example apparatus.

FIG. 22A is a diagram illustrating an example user plane protocol stack.

FIG. 22B is a diagram illustrating an example signaling protocol stack.

FIG. 23 is a diagram illustrating an example of the broadcast procedure over sidelink.

FIG. 24 is a diagram illustrating an example of the groupcast procedure over sidelink.

FIG. 25 is a diagram illustrating an example of the unicast procedure sidelink.

FIG. 26A is a diagram illustrating an example of a first frame.

FIG. 26B is a diagram illustrating an example of DL channels within a subframe.

FIG. 26C is a diagram illustrating an example of a second frame.

FIG. 26D is a diagram illustrating an example of UL channels within a subframe.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

When there is no communication to be exchanged between a base station and a UE for a period of time, the UE may transition to a radio resource control (RRC) idle mode. If the base station receives data or information for the UE that is in the idle mode, the base station may page the UE in order to provide the data or information to the UE. The base station may send the page for any of a number of reasons, e.g., to trigger a radio resource control setup with the UE, to provide a system information modification to the UE, to provide a public warning system notification to the UE, among other examples. In some scenarios, if a UE in an idle mode moves out of the coverage of the base station, the UE may not reliably receive the paging message from the base station outside of the transmission range of the base station.

Aspects presented herein may enable a base station to reliably transmit one or more paging messages to a UE that is outside the transmission range of the base station. Aspects presented herein may enable a base station to page a target UE in an idle mode. Aspects of the present application provide for improved coverage for the page by transmitting a message (e.g., a relay message) to another wireless device (e.g., a relay UE) to be relayed to the target UE over sidelink. A relay UE may receive paging information for the target UE from the base station over an access link and may provide the paging information to the target UE over sidelink. The term “relay UE” refers to a UE that receives the page for another UE from the base station and transmits information about the page, or the page itself, to the target UE. The term “target UE” refers to the UE that the base station is attempting to page, e.g., the UE to which the content of the page is directed. The relay UE may be in a position to reliably receive the page from the base station and to reliably transmit over sidelink to the target UE. The provision of the paging information to the target UE through a distributed environment provided by sidelink may help to improve latency, reliability, and efficiency of the wireless communication system. For example, a UE may still be able to receive one or more messages associated with paging from a base station if the UE is not within a transmission range of the base station.

According to one or more aspects, a UE, which may be referred to herein as a relay UE or a second UE, receives a paging message for a first UE from a base station while the relay UE is in an RRC idle mode or an RRC inactive mode. Then, the relay UE transmits the paging message to the first UE over sidelink. In some aspects, the relay UE may remain in the RRC idle or RRC inactive mode. In other aspects, the relay UE may transition to an RRC connected mode as a part of receiving or relaying the paging message to the first UE. In some aspects, a base station determines to page a first UE that is in an inactive state or an idle state. The base station transmits a paging message for the first UE to a second UE in an RRC idle mode or an RRC inactive mode, the paging message to be relayed to the first UE over sidelink.

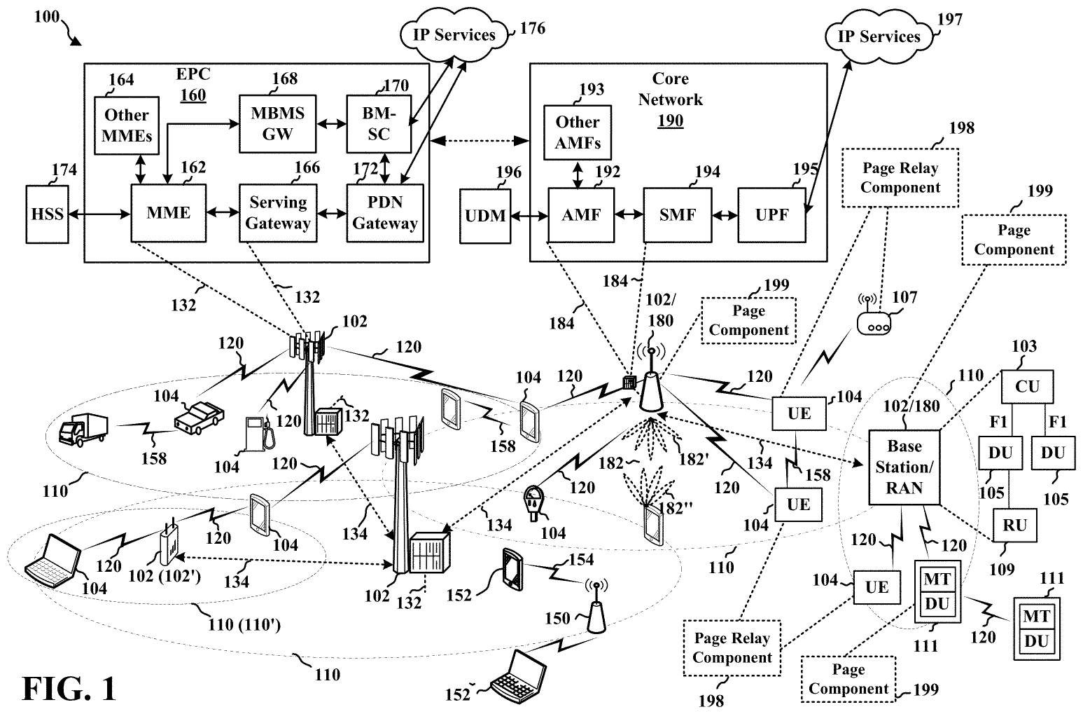

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

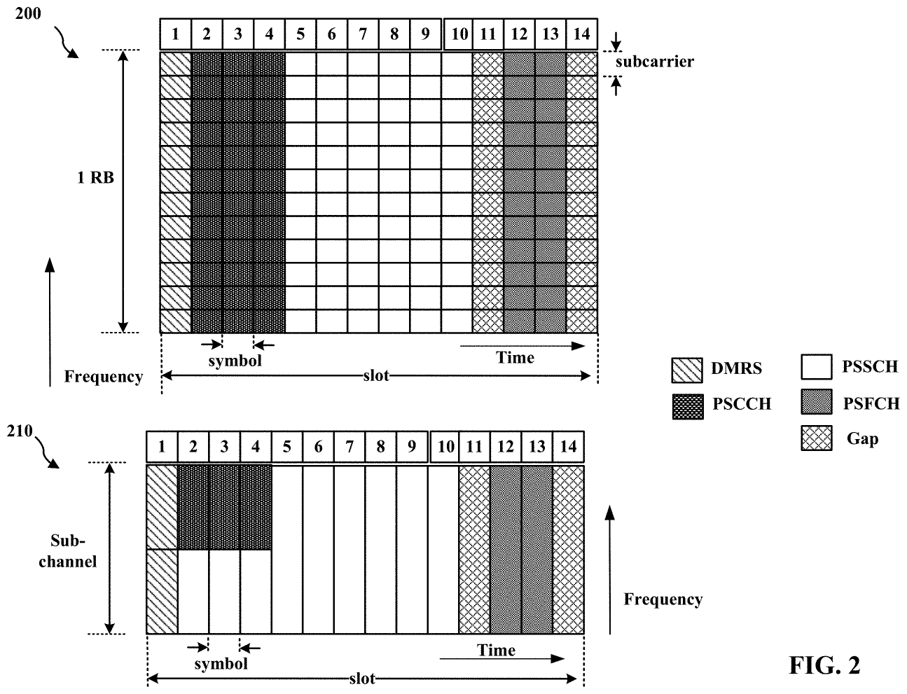

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

A UE 104 that is capable of communicating based on sidelink may include a page relay component 198 configured to receive paging information for a target UE from a base station 102 or 180 while in an RRC idle mode or an RRC inactive mode and to provide the paging information to another UE 104 that is the target UE via sidelink. The base station 102 or 180 may include a page component 199 configured to determine to page a target UE 104 and to transmit paging information to a relay UE 104 in an RRC idle mode or an RRC inactive mode to be provided to the target UE 104 over sidelink. Although the following description may be focused on 5G NR, the concepts described herein may be applicable to other similar areas, such as LTE, LTE-A, CDMA, GSM, and other wireless technologies.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., an Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 103, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 103, the DU 105, and the RU 109. A RAN may be disaggregated with a split between the CU 103 and an aggregated DU/RU. The CU 103 and the one or more DUs 105 may be connected via an F1 interface. A DU 105 and an RU 109 may be connected via a fronthaul interface. A connection between the CU 103 and a DU 105 may be referred to as a midhaul, and a connection between a DU 105 and an RU 109 may be referred to as a fronthaul. The connection between the CU 103 and the core network may be referred to as the backhaul. The RAN may be based on a functional split between various components of the RAN, e.g., between the CU 103, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 103 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 103 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G, NR, two initial operating bands have been identified as frequency range designations Frequency Range 1 (FR1) (410 MHz 7.125 GHz) and Frequency Range 2 (FR2) (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

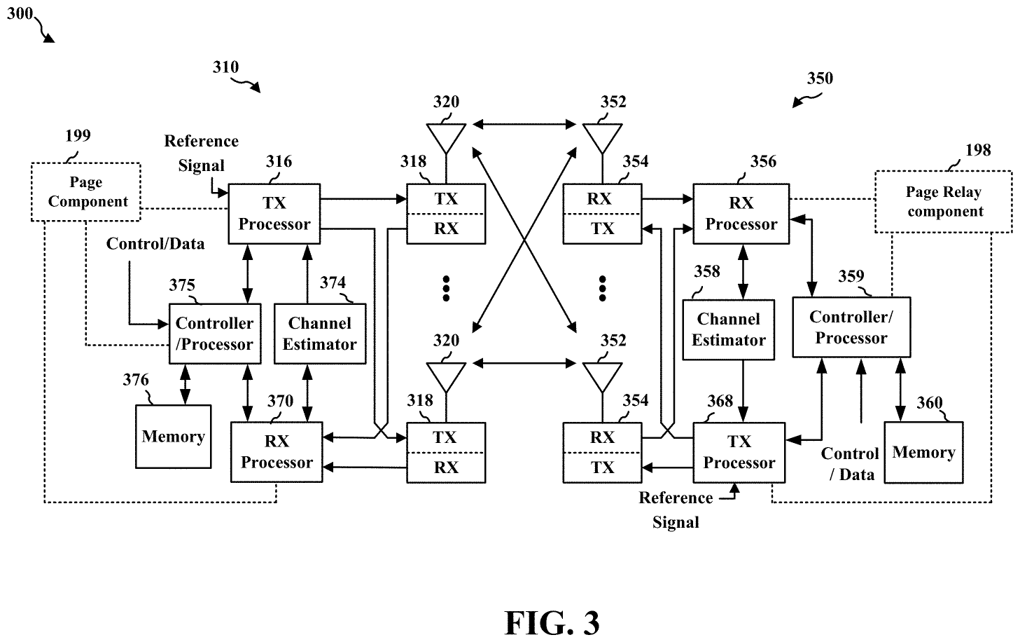

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiple (OFDM) subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an acknowledgment (ACK) and/or negative acknowledgment (NACK) protocol to support hybrid automatic repeat request (HARQ) operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with the page relay component 198 of FIG. 1 in order to relay a page from a base station to a target UE over sidelink.

At least one of the TX processor 316, the RX processor 370, and the controller/processor 375 may be configured to perform aspects in connection with the page component 199 of FIG. 1 in order to provide paging information to a relay UE to be provided to a target UE over sidelink.

A base station (e.g., the base station 102 or 180) may page a UE (e.g., UE 104) for various reasons. For example, the base station may page the UE to trigger RRC setup. The base station may page a UE in an RRC idle or RRC inactive state to trigger a transition to an RRC connected state in order to transmit data to the UE, for example. The base station may page a UE to indicate a modification of system information to the UE. The base station may pave a UE to provide an alert, such as a public warning system alert, an earthquake and tsunami warning system (ETWS) notification, commercial mobile alert system (CMAS) notification, and/or an emergency message notification, etc. The UE may operate based on a discontinuous reception (DRX) cycle in which the UE wakes up to monitor a paging occasion. If the UE does not receive a page, the UE may return to a sleep mode or a lower power mode in which the UE does not monitor for a physical downlink control channel (PDCCH) from the base station. If the UE does receive a page from the base station, the UE may prepare to receive additional downlink messages from the base station. The UE may monitor one monitoring occasion per discontinuous reception (DRX) cycle, in some examples. The paging occasion may include a set of PDCCH monitoring occasions and may include multiple time slots in which the UE may receive paging DCI from the base station.

In order to page the UE, the base station may send a PDCCH message that indicates resources for a corresponding physical downlink shared channel (PDSCH). For example, the PDCCH message may be a downlink control information (DCI) format 1_0 message for which the base station scrambles the cyclic redundancy check (CRC) bits using a paging radio network temporary identifier (P-RNTI). If the UE receives the DCI and determines that the DCI has been scrambled with the P-RNTI, the UE may receive the corresponding paging message on PDSCH and determine whether the PDSCH indicates that the UE is being paged. The paging message in the PDSCH may include a UE identifier that the UE uses to determine that the paging message is directed to the UE. If the UE's identifier is included in the PDSCH associated with the DCI scrambled with the P-RNTI, the UE may determine that the base station is paging the UE and may continue to monitor for communication from the base station.

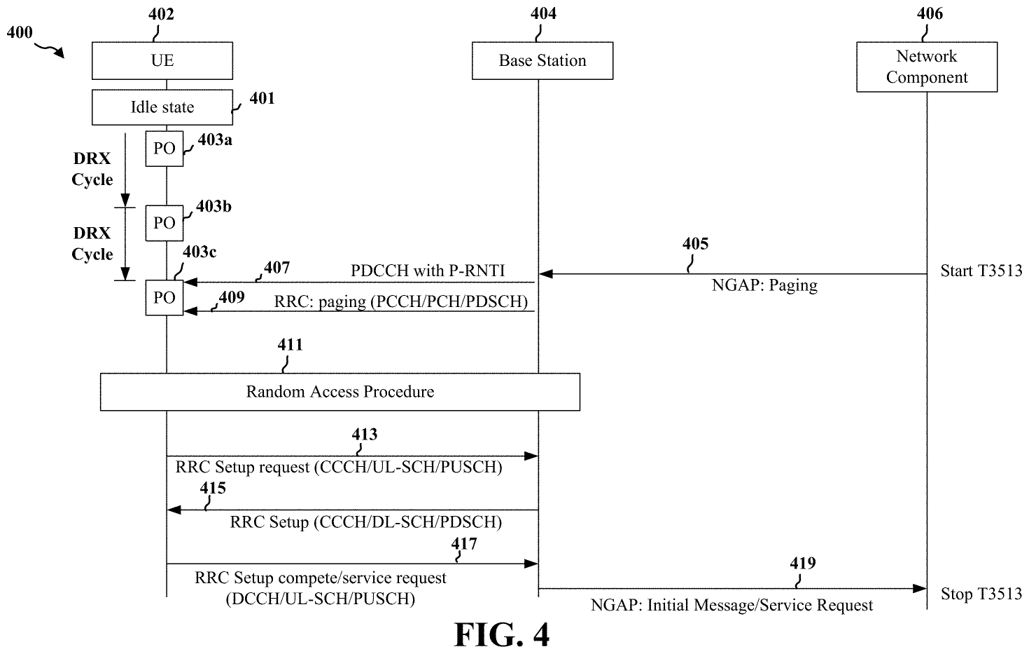

FIG. 4 illustrates an example communication flow 400 that includes paging a UE in an RRC idle state. In FIG. 4, the UE is in an RRC idle state 401. The UE 402 monitors for PDCCH from the base station 404 during paging occasions 403a, 403b, and 403c according to a DRX cycle that the base station 404 configured for the UE 402. The base station 404 receives paging information 405 for the UE 402 from the network 406, e.g., from an AMF such as AMF 192 in FIG. 1. In response to receiving the paging information 405 from the network 406, the base station 404 transmits a PDCCH 407 having the CRC bits scrambled with a P-RNTI. The base station 404 transmits the PDCCH 407 to the UE 402 during the paging occasion 403c. The PDCCH 407 indicates resources for a corresponding PDSCH message. In response to receiving the PDCCH 407 based on the P-RNTI, the UE 402 receives the PDSCH that includes a paging message for the UE 402. The paging message may indicate an identifier for the UE 402 that informs the UE 402 that the paging message is for the UE 402. In response to receiving the paging message in the PDSCH 409, the UE 402 transitions to an RRC connected state with the base station 404. The UE may perform steps of a random access procedure 411 in order to establish, or re-establish, the RRC connection with the base station 404. Following the random access procedure, the UE 402 may transmit an RRC setup request 413. The base station 404 may respond with an RRC set up message 415, and the UE 402 may respond with an RRC set complete message and/or a service request 417 for the network. If the UE 402 transmits a service request, the base station 404 sends the initial message/service request 419 to the network 406. In FIG. 4, the base station 404 does not have the context for UEs in an RRC idle state. Thus, the core network, e.g., the AMF, initiates the paging to the UE by sending an NG application protocol (NGAP) paging message to the base station 404 to initiate the paging to the target UE 402. The base station 404 then sends the RRC paging message to the target UE 402. The “target UE” is the UE to which the paging is directed or the intended final recipient of the paging message.

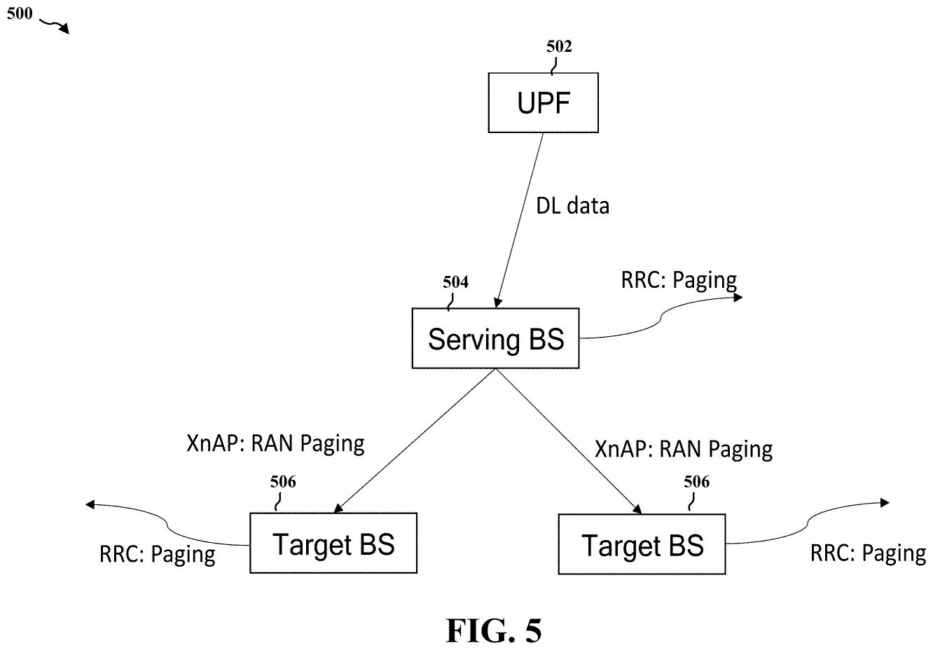

For a UE in an RRC inactive state rather than an RRC idle state, the serving base station has the context of the UE. Thus, the serving base station may initiate paging for the target UE. FIG. 5 illustrates an example 500 in which the serving base station 404 receives downlink data for a UE from the core network, e.g., from UPF 502. The serving base station 504 sends an Xn Access Protocol (XnAP) paging message for the target UE to one or more target base stations 506. The target base station(s) 506 then transmit the RRC paging message to the UE, as described in connection with 407 and 409 in FIG. 4. When the inactive UE receives the paging message, the inactive UE may re-establish the connection with the base station in order to receive the downlink data.

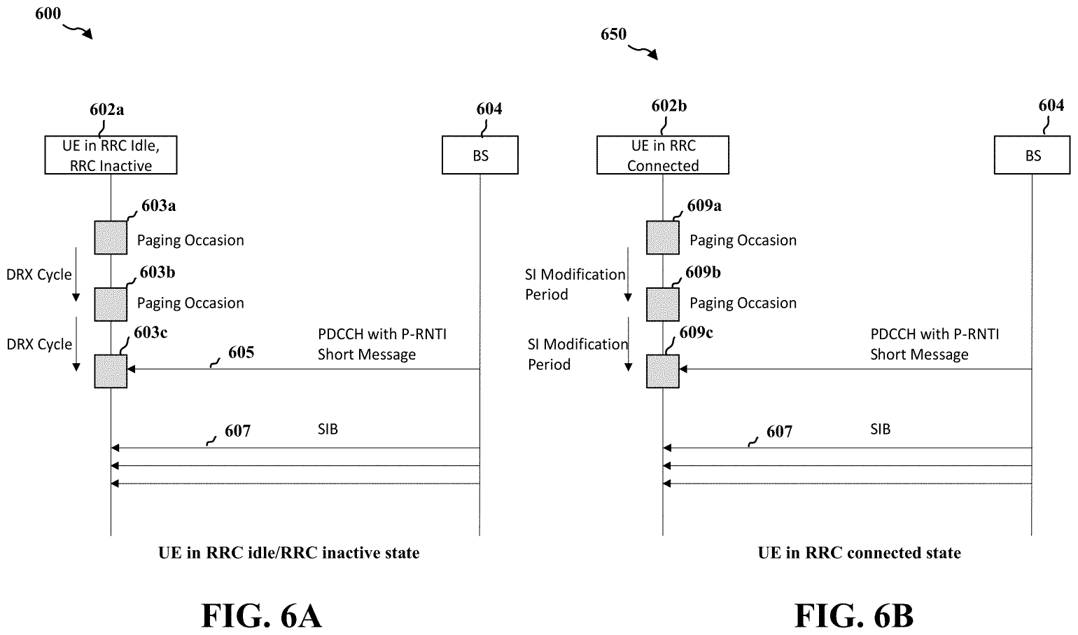

FIG. 6A illustrates an example communication flow 600 for paging an inactive or idle UE to update system information, and FIG. 6B an example communication flow 650 for paging an RRC connected UE to update system information. The UE, whether the UE 602a in the RRC idle state or the RRC inactive state or the RRC connected UE 602b, monitors for PDCCH from the base station 604 during paging occasions. When the UE receives a page 605, e.g., a PDCCH having the CRC bits scrambled with a P-RNTI, the UE monitors for updated system information 607. After sending the page 605, the base station 604 may transmit the updated system information 607 multiple times or in multiple messages, as illustrated in FIGS. 6A and 6B. The PDCCH transmitted as the page 605 may include message, such as a message indicating that the page is for the system information update. For example, the message may be in DCI format 1_0 that indicates that the system information has been updated or that indicates an upcoming warning message, e.g., an ETWS/CMAS message. In the communication flow 600 in FIG. 6A, the paging occasions 603a, 603b, and 603c for the UE 602a may be based on a DRX cycle of the UE 602a. In FIG. 6B, the paging occasions 609a, 609b, 609c for the UE 602b are based on a system information modification period. In the example in FIGS. 6A and 6B, there may be no use of an NGAP message, an XnAP message or an RRC paging message, and the page may instead be provided to the UE 602a or 602b through the PDCCH transmission, e.g., page 605.

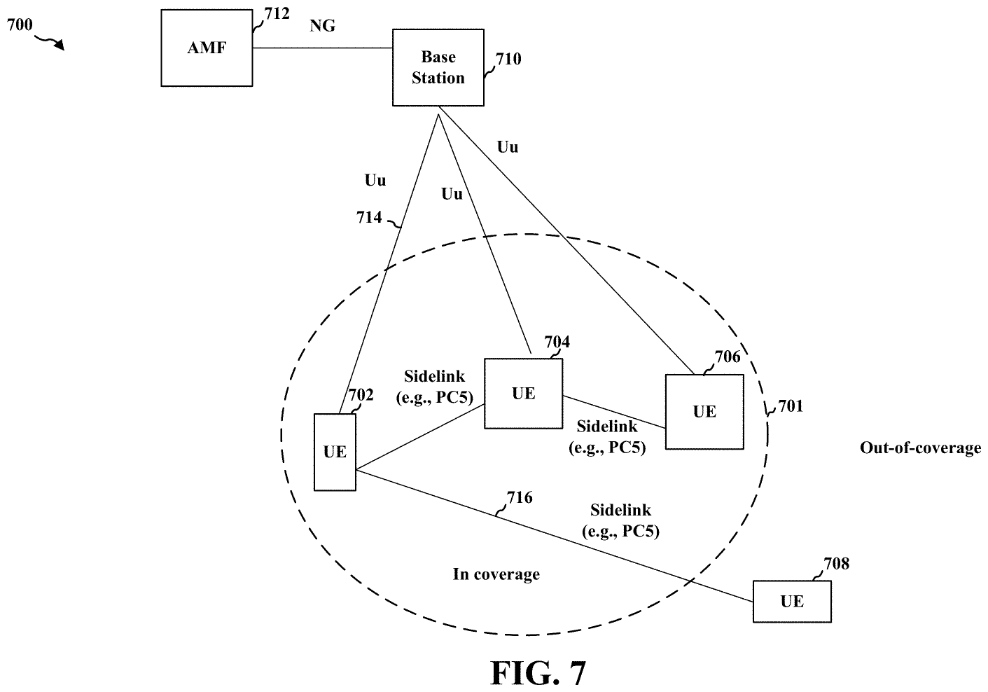

At times, a UE may be out of coverage of a base station. FIG. 7 illustrates a communication system 700 including a base station 710 that provides a range of coverage 701. The UEs 702, 704, and 706 are within the coverage 701 of the base station 710. The UE 708 is outside of the coverage of the base station 710. If the base station 710 has a paging message for the UE 708, the UE 708 may not reliably receive the paging message. Aspects presented herein provide for a paging message to be relayed to the out-of-coverage UE 708 over sidelink. For example, a wireless device that is within the coverage 701 may receive the paging message from the base station 710 and provide the paging information to the out-of-coverage UE 708. For example, a UE 702 that is in the coverage 701 may receive the paging message for the UE 708 from the base station 710 over an access link 714 with the base station 710 based on an Uu interface and may provide the paging message or information from the paging message to the out of coverage UE 708 over a sidelink 716. In some aspects, the UE 702 may provide the message to the UE 708 based on a PC5 interface. The UE 708 that is the intended recipient of the paging message may be referred to herein as the “target UE.” The UE 702 that receives the paging message from the base station 710 and provides paging information to the target UE may be referred to as a “relay UE.” Although aspects are described herein for a relay “UE,” the aspects may be applied by any device capable of transmitting via sidelink, such as an RSU, etc.

The concepts presented herein may be applied for a relay UE that is in an RRC inactive or RRC idle state. The concepts presented herein may be applied for a relay UE that is in an RRC connected state. Thus, the access link 714 (e.g., Uu interface) may be connected, inactive, or idle. The source of the paging message may be the base station 710, another base station that was previously serving the UE, or the AMF 712, such as described in connection with FIGS. 4-6.

Sidelink provides a distributed network that enables communication directly between devices. The aspects presented herein provide for extended network coverage for paging messages by relaying paging messages from a base station over sidelink. If a target UE is out of coverage and the base station cannot page the UE directly, the base station may request a relay UE to forward the paging message to the target UE in order to reach the target UE. In some examples, the transmission of a paging message may fail due to a channel state between the base station and the target UE. The relayed paging presented herein enables the base station to use diversity by repetition of the paging message to the target UE via sidelink. The added diversity may reduce the latency for the target UE to receive the paging message and connect to the base station to receive the pending data from the base station. In some examples, the base station may combine paging messages for multiple target UEs into a single relay message to a relay UE. The combined paging messages may reduce signaling overhead on the Uu link between the base station and the paging UE. Thus, the relay of a paging message from a base station to a target UE over sidelink may improve performance in the communication system, such as improving latency, reliability and/or efficiency.

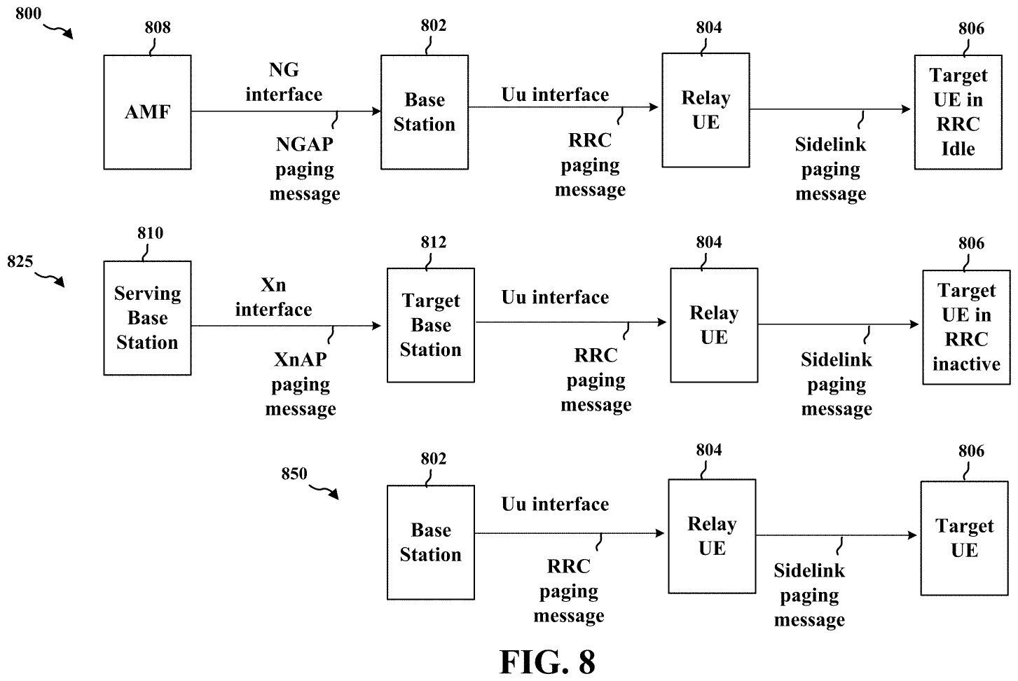

FIG. 8 shows example scenarios for paging target UEs having different connection states and/or for different paging purposes. In a first example 800, the target UE 806 is in an RRC idle state, and the page may originate at the AMF 808, such as described in connection with FIG. 4. The AMF provides the NGAP page to the base station 802 that transmits the RRC page over an access link to the relay UE 804. The AMF 808 may include information about the target UE 806 in the NGAP paging message. The relay UE 804 then transmits paging information to the target UE 806 over sidelink. If the AMF initiates the paging of the target UE 806, the AMF have may selected the relay UE 804. If the AMF 808 selects the relay UE 804, the AMF may include information about the relay UE in the NGAP paging message that the AMF 808 sends to the base station 802. If the base station 802 selected the relay UE, the base station may have obtained information about the relay UE prior to selecting the relay UE. In some examples, the target UE 806 may select the relay UE. The relay UE 804 may send information about an association between the target UE 806 and the relay UE 804 to the base station 802. The base station 802 may use the information about the relay UE, whether received from the AMF 808 or the relay UE 804, to send the paging message for the target UE 806 to the relay UE 804.

In the second example 825, the target UE 806 is in an RRC inactive state. A serving base station 810 for the target UE 806 initiates the paging of the target UE 806 by sending an XnAP paging message to a target base station 812 that transmits the RRC paging message for the target UE 806 to the relay UE 804 over an access link. The relay UE 804 then transmits paging information to the target UE 806 over sidelink.

In the third example 850, the base station may initiate the paging message for a system information update or for a warning system message, such as an ETWS or CMAS, such as described in connection with FIG. 6A or 6B. The base station 802 transmits the RRC page over an access link to the relay UE 804. The relay UE 804 then transmits paging information to the target UE 806 over sidelink.

FIG. 8 illustrates different states for the target UE 806. The relay UE 804 may also operate based on different RRC states, such as an RRC idle or inactive state or an RRC connected state. In some examples, the relay UE 804 may monitor for PDCCH in a discontinuous manner. For example, the relay UE 804 may be in an RRC idle or RRC inactive state in which the relay UE 804 monitors for PDCCH during paging occasions on the Uu link between the relay UE 804 and the base station 802 or 812. The paging occasions may be based on a DRX cycle for the relay UE, as described in connection with the UE 402 or 602a. In other examples, the paging occasions may be based on a system information modification period, such as described in connection with the UE 602b.

In some examples, the base station may transmit paging to the target UE based on a configuration for the target UE. For example, the base station may transmit the paging message for the target UE 806 during paging occasions based on the DRX cycle of the target UE 806. A paging relay association may be established between the relay UE 804 and the target UE 806. The association may be initiated by the target UE 806 that selects the relay UE 804. Alternately, the association may be initiated by the network or by the relay UE 804. Once the paging relay association is established, the relay UE 804 may monitor for paging messages during the target UE's paging occasions over the Uu interface.

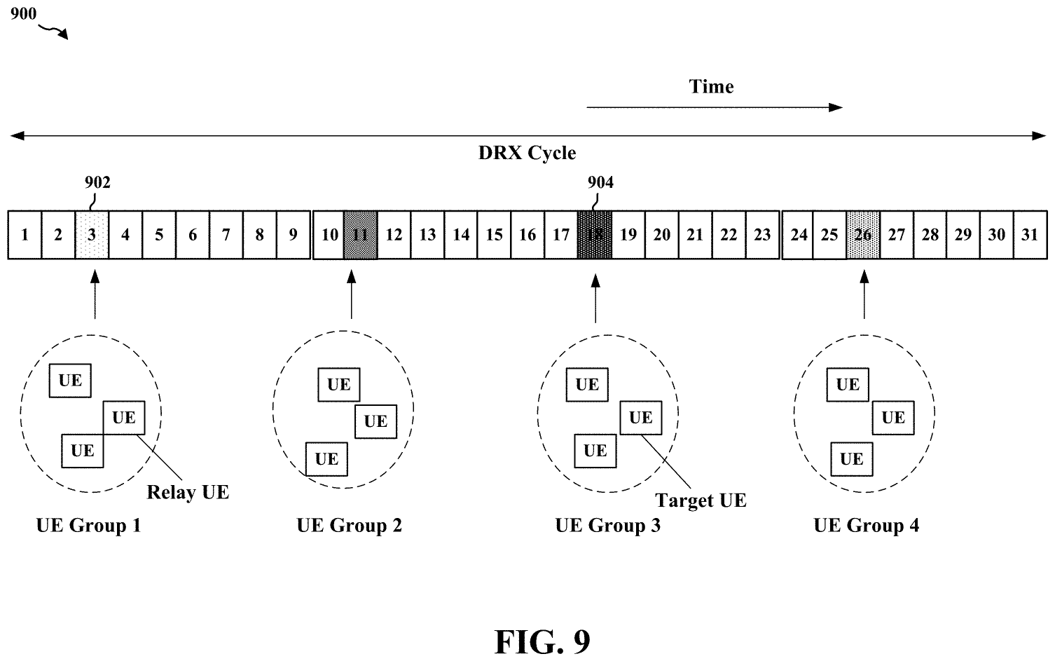

FIG. 9 illustrates an example of time resources 900 of a DRX cycle including paging occasions for different groups of UEs. The relay UE may be in a first group of UEs that is configured to monitor paging occasion 902 within the DRX cycle. The target UE may be in a different group of UEs that is configured to monitor paging occasion 904 within the DRX cycle.

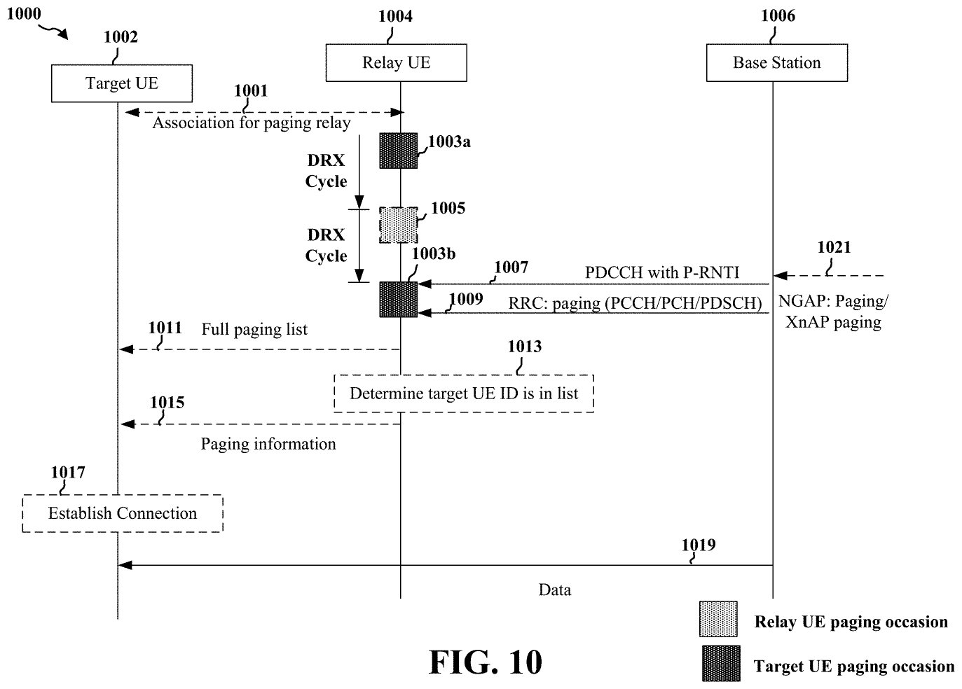

FIG. 10 illustrates an example communication flow 1000 including relay of a page that is transmitted by a base station 1006 to a target UE 1002. An association may be established, at 1001, between the target UE 1002 and a relay UE 1004 for the relay of paging messages from the base station 1006 to the target UE 1002 by the relay UE 1004. Once an association is established between the relay UE 1004 and the target UE 1002, the relay UE 1004 may monitor the paging occasions 1003a, 1003b (e.g., paging occasion 904 in FIG. 9) of the target UE 1002. If the relay UE 1004 is also operating based on a DRX cycle, the relay UE 1004 may also monitor its own 1005 (e.g., paging occasions 904 in FIG. 9) in addition to monitoring the paging occasions 1003a, 1003b of the target UE.

The base station 1006 may transmit DCI 1007 and PDSCH 1009 with paging information to the target UE. A paging message, e.g., the PDSCH 1009, may include a paging record list of UEs that are being paged. When the relay UE (e.g., relay UE 804) receives a paging message (e.g., DCI 1007 and PDSCH 1009) in a paging occasion 1003b of the target UE 1002, the relay UE 1004 may search for the target UE's identity in a paging record list of the paging message. The relay UE 1004 may know the target UE's identity, e.g., based on an association message, e.g., 1001, from the target UE 1001 and/or from the network. If the relay UE 1004 determines, at 1013, that the paging message is directed to the target UE 1002 based on finding the target UE's identity in the list, the relay UE 1004 may prepare and send a sidelink paging message 1015 to the target UE 1002 over sidelink. In some examples, the relay UE 1004 may transmit the received paging message to the target UE 1002 over sidelink. In some examples, the relay UE 1004 may provide relay information to the target UE 1002 over sidelink based on the paging message from the base station, e.g., without sending the full record list. In some examples, rather than determining whether the target UE 1002 is identified in the paging message from the base station, the relay UE 1004 may provide a paging message 1011 to the target UE 1002 over sidelink with the full record list from the paging message (e.g., 1009) that the relay UE received from the base station. For example, the relay UE 1004 may send the full record list to the target UE 1002 without reading the paging message. The target UE 1002 may determine whether or not the target UE identity is included in the list that it receives from the relay UE 1004. In response to receiving the paging message 1011 or 1015, the target UE 1002 may establish an RRC connection with the base station 1006, at 1017, and receive the data 1019 from the base station 1006. As illustrated at 1021, the paging of the target UE 1002 may be initiated by an AMF or by a serving base station, such as described in connection with any of FIGS. 4-8.

If the base station transmits the paging message to the target UE in a paging occasion for the target UE and based on a configuration for the target UE, the paging message may be relayed to the target UE without any changes on the Uu interface for the base station. As well, the relay UE and the target UE may receive the paging message from the base station simultaneously. That way, if the target UE is within coverage of the base station, the target UE can respond to the paging message without waiting for the message to the relayed.

In some examples, the base station may send the paging message for the target UE to the relay UE based on the paging occasion and/or configuration of the relay UE. In such an example the relay UE of FIG. 9 would monitor paging occasion 902 without monitoring paging occasion 904. This example may reduce power consumption of the relay UE by not having the relay UE monitor the paging occasion of the target UE. If the relay UE is associated with multiple target UEs, the relay UE may avoid monitoring multiple monitoring occasions, e.g., one for each of the multiple target UEs.

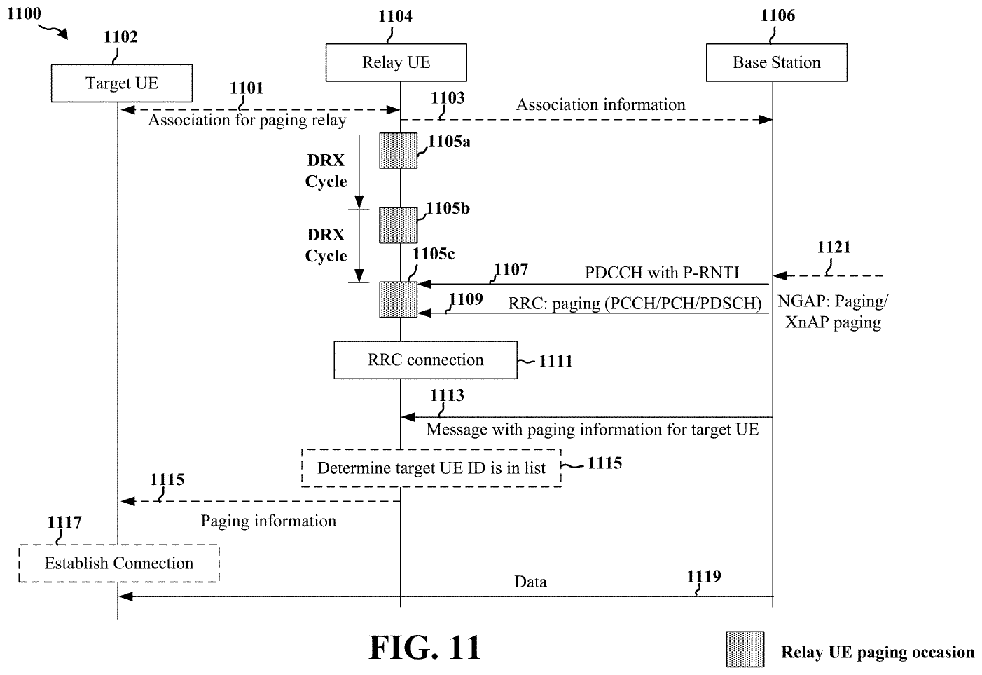

FIG. 11 illustrates an example communication flow 1100 including the transmission of a paging message (e.g., 1107 and 1109) to a relay UE 1104 in order to relay a paging message to the target UE 1102. In this example, in order to send a paging message to the target UE 1102, the base station 1106 first sends a paging DCI 1107 and a paging message 1109 to the relay UE 1104. The relay UE 1104 may transition to an RRC connected state, at 1111. The transition may include the aspects described in connection with FIG. 4, such as performing random access and requesting an RRC setup. The base station 1106 may then transmit an additional message 1113 to the relay UE 1104 with paging information for the target UE 1102.

As the relay UE 1104 is paged at 1107 and 1109 based on its own paging occasion, the relay UE 1104 may monitor its own paging occasions 1105a, 1105b, 1105c without monitoring the paging occasions of the target UE(s), in contrast to the relay UE 1004 in FIG. 10. For example, in FIG. 9, the relay UE may monitor paging occasion 902 and may skip paging occasion 904. In order to page the relay UE 1104 to relay paging information to the target UE 1102, the base station knows about the association between the target UE 1102 and the relay UE 1104. After the association for paging relay is established between the target UE 1101 and the relay UE 1104, at 1101, the relay UE may provide information about the association to the base station, at 1103. The relay UE may inform the base station 1106 that the relay UE 1104 will relay paging messages from the base station 1106 to the target UE 1102. The additional message 1113 may be a DCI format 1_0 message, for example.

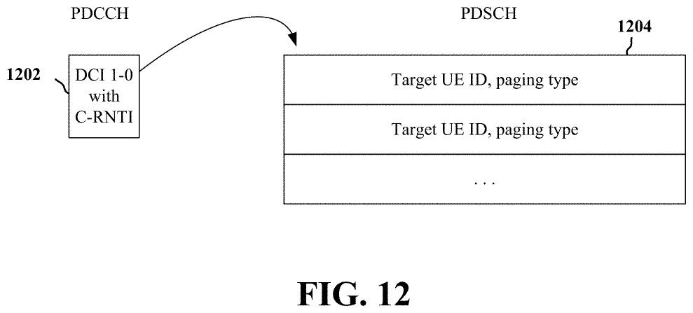

In some examples, the additional message 1113 may include bits scrambled with a cell radio network temporary identifier (C-RNTI). The C-RNTI may indicate the relay UE's identity so that the relay UE 1102. The message 1113 may include information about one or more target UEs. FIG. 12 illustrates an example of PDCCH 1202 and PDSCH 1204 that may be comprised in the message 1113. For example, the message 1113 may include the PDCCH with the C-RNTI that identifies the relay UE 1104 and a PDSCH that includes one or more sets of paging information. Each set of information may include a target UE ID and a paging type.

In some examples, the additional message 1113 may include a message, e.g., in DCI 1_0 that indicates that the message 1113 is a relay request. For example, rather a DCI having bits scrambled with a C-RNTI for the relay UE 1104, the DCI may include a field or content that indicates the purpose of the DCI to inform a relay UE about a paging message for a target UE. In other examples, the DCI may indicate the PDSCH without an indication for paging relay, and the PDSCH may include information in the payload that informs the relay UE 1104 to relay paging information to the target UE 1102. For example, a MAC-CE may include paging information about the target UE to which the relay UE is requested to provide the paging information.

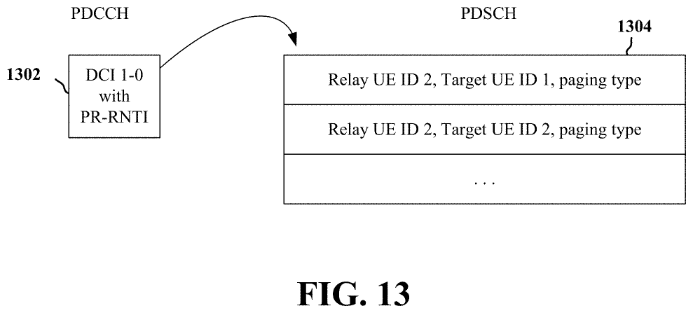

In some examples, the additional message 1113 may include PDCCH, e.g., DCI format 1_0, with bits scrambled based on a paging relay RNTI (PR-RNTI) that indicates to the relay UE 1104 that the message is for the purpose of relaying a page to a target UE. FIG. 13 illustrates an example of PDCCH 1302 and PDSCH 1304 that may be comprised in the message 1113. For example, the message 1113 may include the PDCCH with the PR-RNTI and a PDSCH 1304 that includes one or more sets of paging information. Each set of information may include a combination of a relay UE ID, a target UE ID, and a paging type.

As illustrated in FIG. 11, the relay UE 1104 may determine that the target UE 1102 is identified in the message 1113 (e.g., the target UE ID in 1204 or 1304) and may transmit paging information 1115 to the target UE over sidelink based on the message. The paging information 1115 may be based on the paging type identified for the target UE ID in the PDSCH 1204 or 1304. In response to receiving the paging information 1115, the target UE 1102 may establish a connection with the base station 1106, at 1117, in order to receive the downlink data 1119. As illustrated at 1121, the paging of the target UE 1102 may be initiated by an AMF or by a serving base station, such as described in connection with any of FIGS. 4-8.

For a relay UE in an RRC connected state, the base station may send the additional message 1113 in FIG. 11 without first paging the relay UE 1104.

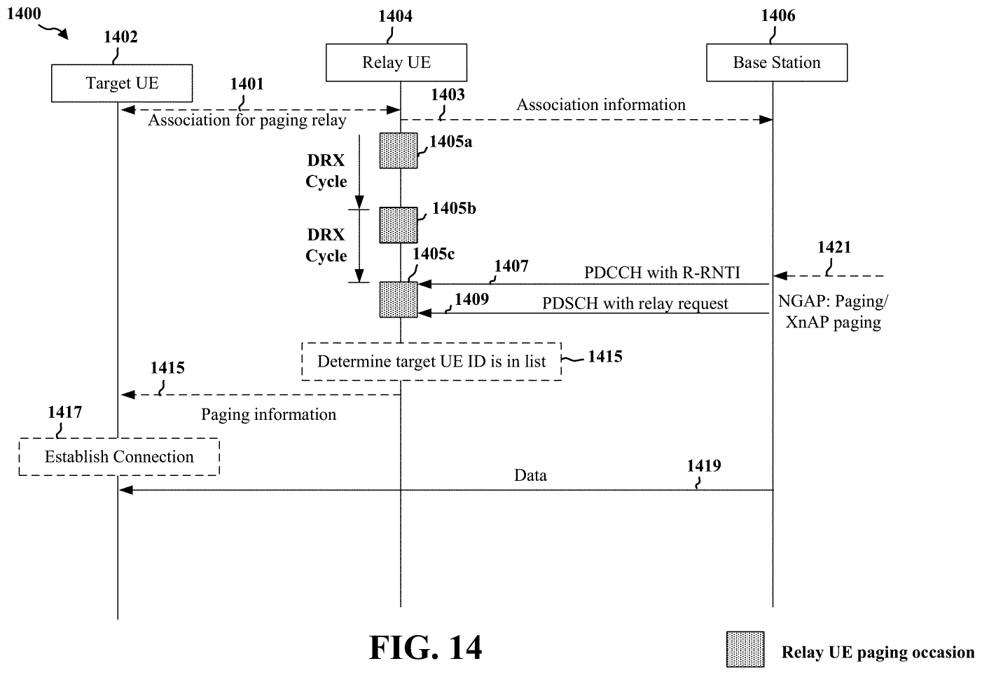

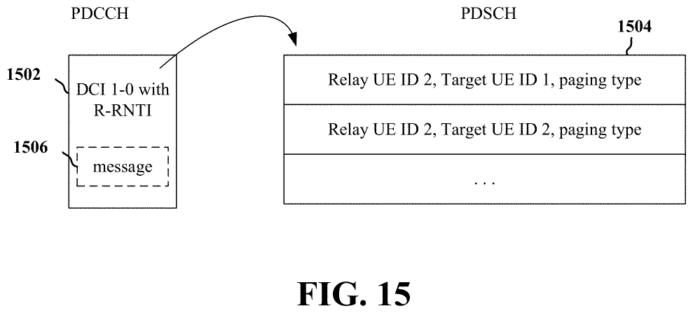

FIG. 14 illustrates an example communication flow 1400 that includes a new type of paging for a relay request. In this example, in order to send a paging message to the target UE 1402, the base station 1406 first sends a paging relay DCI 1407 and corresponding PDSCH 1409 to the relay UE 1404. FIG. 15 illustrates an example of PDCCH 1502 and PDSCH 1504 that may correspond to the PDCCH 1407 and PDSCH 1409 in FIG. 14. For example, the PDCCH 1502 may include bits scrambled with the R-RNTI that indicates the message is for a relay request. In some examples, the PDCCH 1502 may include a message 1506 comprising a few bits, e.g., less than 10 bits or between 3-8 bits, that indicate the paging message comprises a relay request. Upon receiving the request, e.g., 1407, the relay UE 1404 obtains the resources for the PDSCH and receives the corresponding PDSCH 1409. As illustrated for the PDSCH 1504, the PDSCH may include one or more sets of paging information. Each set of information may include a combination of a relay UE ID, a target UE ID, and a paging type. In contrast to FIG. 11, the relay UE 1404 may remain in the RRC inactive/RRC idle mode without transitioning to an RRC connected state in order to receive an additional message because the PDCCH indicated that the paging message was a relay request.

As the relay UE 1404 is paged, e.g., at 1407 and 1409, based on its own paging occasion, the relay UE 1404 may monitor its own paging occasions 1405a, 1405b, 1405c without monitoring the paging occasions of the target UE(s), in contrast to the relay UE 1004 in FIG. 10. For example, in FIG. 9, the relay UE may monitor paging occasion 902 and may skip paging occasion 904. In order to page the relay UE 1404 to relay paging information to the target UE 1402, the base station knows about the association between the target UE 1402 and the relay UE 1404. After the association for paging relay is established between the target UE 1401 and the relay UE 1404, at 1401, the relay UE may provide information about the association to the base station, at 1403. The relay UE may inform the base station 1406 that the relay UE 1404 will relay paging messages from the base station 1406 to the target UE 1402.

As illustrated in FIG. 14, the relay UE 1404 may determine that the target UE 1402 is identified in the PDSCH 1409 (e.g., the target UE ID in 1504) and may transmit paging information 1415 to the target UE over sidelink based on the message. The paging information 1415 may be based on the paging type identified for the target UE ID in the PDSCH 1504. In response to receiving the paging information 1415, the target UE 1402 may establish a connection with the base station 1406, at 1417, in order to receive the downlink data 1419. As illustrated at 1421, the paging of the target UE 1402 may be initiated by an AMF or by a serving base station, such as described in connection with any of FIGS. 4-8.

The examples in FIG. 14 may help to reduce power consumption at the relay UE by having the relay UE determine the paging relay request without transitioning to an RRC connected state. By avoiding random access, latency may be improved. Wireless resources may be conserved by reducing signaling between the relay UE and the base station. As well, in FIG. 14 and FIG. 11, the messages can be provided to the relay UE without setting up an association between the relay UE and the target UE in advance.

In some examples, the sidelink messages (e.g., 1015, 1115, and/or 1415) may include a layer-2 ID (L2 ID) for sidelink communication over a PC5 reference point. As one example of sidelink communication, the L2 ID may include a L2 ID for V2X communication over a PC5 reference point. The L2 ID may include a source L2 ID and a destination layer 2 ID. The source and destination L2 IDs may be included in layer-2 frames sent on a layer-2 link from the relay UE to the target UE. The source layer-2 IDs may be self-assigned by the UE originating the corresponding layer-2 frames. In some examples, the destination layer-2 ID may be mapped to a sidelink (e.g., V2X) service type of the sidelink application for broadcast. In some examples, the destination layer-2 ID may be mapped to a sidelink (e.g., V2X) service type of the sidelink application for groupcast. A default destination layer-2 ID may be mapped for initial signaling to establish a unicast connection and the service type of the sidelink application. The sets of mapping information may be provisioned to the UE. In some examples, the selection of the destination layer-2 ID may depend on the type of sidelink communication, e.g., whether the sidelink communication will be unicast, broadcast, or groupcast. For example, the destination layer-2 ID for broadcast sidelink communication may be selected based on a mapping between the service type (e.g., a PSID/ITS-AID) and a layer-2 ID. For groupcast sidelink communication, group identifier information may be provided by the application layer, and the UE may convert the provided group identifier into a destination layer-2 ID. Otherwise, the UE may determine the layer-2 ID based on a mapping between the service type (e.g., a provider service identifier (PSID)/intelligent transportation system application identifier (ITS-AID)) and a layer-2 ID. The initial signaling for the establishment of the PC5 unicast link may use a known Layer-2 ID of the communication peer, or a default destination Layer-2 ID associated with the sidelink service type (e.g. PSID/ITS-AID) configured for PC5 unicast link establishment. During the PC5 unicast link establishment procedure, Layer-2 IDs may be exchanged, and may be used for future communication between the two UEs. A UE may establish multiple PC5 unicast links with a peer UE and use the same or different source Layer-2 IDs for these PC5 unicast links. The relay UE 1104 may relay paging information to the target UE over sidelink using a layer-2 ID based on the type of communication (e.g., unicast, broadcast, or groupcast) and/or based on any of these additional aspects.

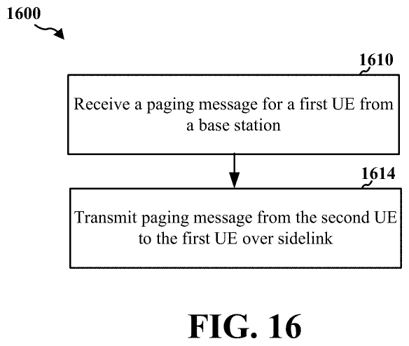

FIG. 16 is a flowchart 1600 of a method of wireless communication including a paging message for a first UE. In some examples, the method may be performed by a second UE (which may be referred to as a relay UE or a relay device) (e.g., the UE 104, the RSU 107, the device 310 or 350, the UE 702, the relay UE 804, 1004, 1104, or 1404; the apparatus 1802). The method may help to extend coverage of a base station, reduce latency in communication, improve reliability, and improve the efficient use of wireless resource through relaying a page from a base station to a second UE over sidelink.

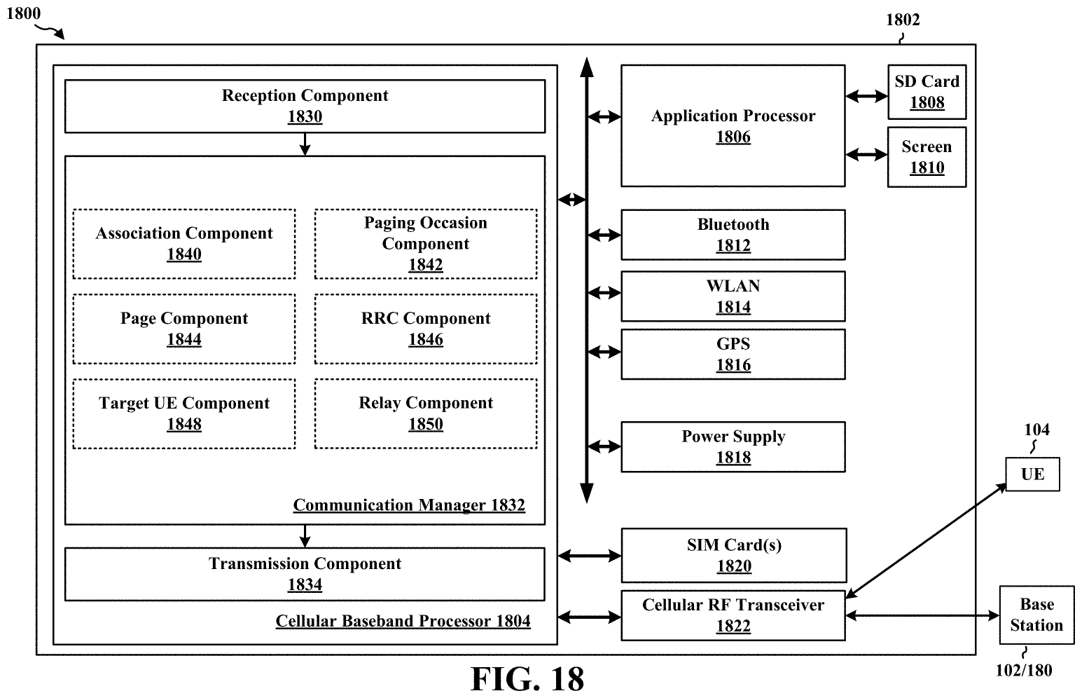

At 1610, the second UE receives a paging message for the first UE from a base station while the second UE is in an RRC idle or RRC inactive state. The first UE may be referred to as the target UE and may be the final destination of the page or the UE that the base station is attempting to page. The second UE may be referred to as a relay UE. The paging message for the first UE may be received by the second UE from the base station over an access link (e.g., Uu link) with the base station, such as described in connection with any of FIGS. 7-15. The reception may be performed, e.g., by the reception component 1830, the page component 1844, and/or the cellular RF transceiver 1822 in the apparatus 1802 in FIG. 18. For example, the paging message may correspond to any of the messages 1007, 1009, 1113, 1407, and/or 1409. The paging message may be received in the paging occasion for the first UE (e.g., 904) that is monitored by the second UE, such as described in connection with FIG. 10. The paging message may be based on a paging configuration for the first UE. For example, the second UE may detect a paging message that was transmitted by the base station to the first UE.

At 1614, the second UE transmits the paging message from the second UE to the first UE over sidelink. The paging message may originate from one of an AMF for the first UE in an RRC idle state; a serving base station of the first UE that is in an RRC inactive state, or the base station, such as described in connection with FIG. 8.

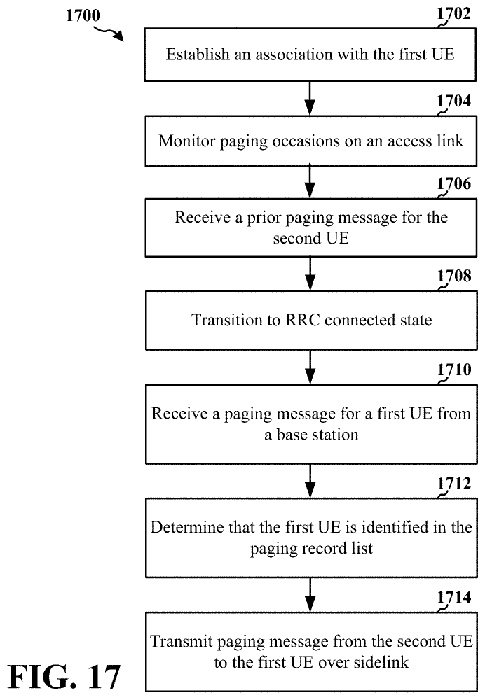

The method of FIG. 16 may include additional aspects described in connection with FIG. 17.

FIG. 17 is a flowchart 1700 of a method of wireless communication. In some examples, the method may be performed by a second UE (which may be referred to as a relay UE or a relay device) (e.g., the UE 104, the RSU 107, the device 310 or 350, the UE 702, the relay UE 804, 1004, 1104, or 1404; the apparatus 1802). The method may help to extend coverage of a base station, reduce latency in communication, improve reliability, and improve the efficient use of wireless resource through relaying a page from a base station to a first UE over sidelink.

At 1710, the second UE receives a paging message for a first UE from a base station. The first UE may be referred to as the target UE and may be the final destination of the page or the UE that the base station is attempting to page. The second UE may be referred to as a relay UE. The paging message for the first UE may be received by the second UE from the base station over an access link (e.g., Uu link) with the base station, such as described in connection with any of FIGS. 7-15. The reception may be performed, e.g., by the reception component 1830, the page component 1844, and/or the cellular RF transceiver 1822 in the apparatus 1802 in FIG. 18. For example, the paging message may correspond to any of the messages 1007, 1009, 1113, 1407, and/or 1409. The paging message may be received in the paging occasion for the first UE (e.g., 904) that is monitored by the second UE, such as described in connection with FIG. 10. The paging message may be based on a paging configuration for the first UE. For example, the second UE may detect a paging message that was transmitted by the base station to the first UE.

At 1714, the second UE transmits the paging message from the second UE to the first UE over sidelink. The paging message may originate from one of an AMF for the first UE in an RRC idle state; a serving base station of the first UE that is in an RRC inactive state, or the base station, such as described in connection with FIG. 8.

In some examples, the second UE may be in an RRC connected state. In some examples, the second UE may be in an RRC idle state or an RRC inactive state. The transmission may be performed, e.g., by the transmission component 1834, the relay component 1850, and/or the cellular RF transceiver 1822 in the apparatus 1802 in FIG. 18.

As illustrated at 1704, the second UE may monitor paging occasions on an access link, where the paging message for the first UE is received by the second UE during a paging occasion. The monitoring may be performed, e.g., by the paging occasion component 1842 in the apparatus 1802 in FIG. 18. As described in connection with FIGS. 9 and 10, the paging occasions comprise a first set of paging occasions for the first UE. The paging occasions further comprise a second set of paging occasions for the second UE.

As illustrated at 1702, the second UE may establish an association with the first UE, where the second UE monitors the first set of paging occasions for the first UE based on the association. For example, the second UE and the first UE may establish an association 1001, 1101, or 1401, such as described in connection with FIG. 10, 11, or 14. The establishment may be performed, e.g., by the association component 1840 in the apparatus 1802 in FIG. 18.

The paging message that is received from the base station, at 1710 may include a paging record list, such as described in connection with PDSCH 1204, 1304 or 1504. As illustrated at 1712, the second UE may determine that the first UE is identified in the paging record list, wherein the second UE transmits the paging message to the first UE in response to determining that the first UE is identified in the paging record list. The determination may be performed, e.g., by the target UE component 1848 in the apparatus 1802 in FIG. 18.

Alternately, the paging message that is received from the base station may include a paging record list, and the second UE may transmit the paging message comprising the paging record list to the first UE, e.g., without checking to see if the first UE is identified in the list. For example, the second UE may transmit the paging message 1011 with the full list.

As illustrated at 1706, the second UE may receive a prior paging message for the second UE, the prior paging message being received in a paging occasion for the second UE. The reception may be performed, e.g., by the reception component 1830, the page component 1844, and/or the cellular RF transceiver 1822 in the apparatus 1802 in FIG. 18. For example, as described in connection with FIG. 11, the UE may receive 1107 and 1109.

At 1708, the second UE may transition to an RRC connected state in response to receiving the prior paging message, and the paging message for the first UE may be received, at 1710, in at least one additional message while the second UE is in the RRC connected state. The transition may be performed, e.g., by the RRC component 1846 in the apparatus 1802 in FIG. 18. For example, the second UE may receive an additional message 1113, such as described in connection with FIG. 11. The at least one additional message may include DCI and a PDSCH message that identifies the first UE and a paging type. FIG. 12 and FIG. 13 illustrate examples of a DCI and PDSCH message. The DCI may include an indication for a relay request and the second UE may transition to the RRC connected state in response to receiving the indication for the relay request. The PDSCH message may include an indication for a relay request, and the second UE may transition to the RRC connected state in response to receiving the indication for the relay request. A MAC-CE may include paging information for the first UE, and the second UE may transition to the RRC connected state in response to receiving the indication for the paging information for the first UE. CRC bits of the DCI may be scrambled with a C-RNTI for the second UE, and the PDSCH message further includes a list of items, each item indicating a paging relay task for a target UE, and wherein each item comprises an identifier for the target UE and a paging type. The CRC bits of the DCI may be scrambled with a PR-RNTI and the PDSCH message may further include a list of items, each item including an identifier for a relay UE, an identifier for the target UE and a paging type.

In some examples, as a part of receiving the paging message at 1710, the second UE may receive DCI while in an idle state or an inactive state and may determine resources for a PDSCH message from the DCI, where the paging message for the first UE is received in the PDSCH message, e.g., such as described in connection with FIG. 14. The PDSCH message may include a first identifier for the first UE, a second identifier for the second UE, and a paging type, such as described in connection with FIG. 15. The second UE may remain in the idle state or the inactive state. The CRC bits of the DCI may be scrambled with an R-RNTI. The second UE may determine to relay the paging message to the first UE based on the CRC bits of the DCI being scrambled with the R-RNTI. The CRC bits of the DCI may be scrambled with a P-RNTI or may include bits comprising an indication for a relay request. The second UE may determine to relay the paging message to the first UE based on the CRC bits of the DCI being scrambled with the P-RNTI

FIG. 18 is a diagram 1800 illustrating an example of a hardware implementation for an apparatus 1802. The apparatus 1802 may be a UE, a component of a UE, an apparatus that implements UE functionality, or may be another wireless device that communicates based on sidelink. The apparatus 1802 may include a base baseband processor, e.g., a cellular baseband processor 1804 (also referred to as a modem), coupled to a cellular RF transceiver 1822. The apparatus 1802 may include at least one antenna coupled to, or comprised in, the RF transceiver. In some aspects, the apparatus may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the device 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802.

The communication manager 1832 includes an association component 1840 that is configured to establish an association with the first UE, e.g., as described in connection with 1702 in FIG. 17. The communication manager 1832 further includes a paging occasion component 1842 that monitors paging occasions on an access link, e.g., as described in connection with 1704 in FIG. 17. The communication manager 1832 further includes a page component 1844 that receives a paging message for a first UE from a base station, e.g., as described in connection with 1706 and/or 1710 in FIG. 17. The communication manager 1832 further includes an RRC component 1846 that transitions to an RRC connected state in response to receiving the prior paging message, e.g., as described in connection with 1708 in FIG. 17. The communication manager 1832 further includes a target UE component 1848 that determines that the first UE is identified in the paging record list, e.g., as described in connection with 1712 in FIG. 17. The communication manager 1832 further includes a relay component that is configured to transmit the paging message from the second UE to the first UE over sidelink, e.g., as described in connection with 1714 in FIG. 17.

The apparatus may include additional components that perform each of the blocks of the algorithm in the flowchart of FIG. 17 or any of the aspects performed by the relay UE 1004, 1104 or 1404 in FIG. 10, 11, or 14. As such, each block in the flowchart of FIG. 17 or any of the aspects performed by the relay UE 1004, 1104 or 1404 in FIG. 10, 11, or 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the cellular baseband processor 1804, includes means for receiving a paging message for a first UE from a base station. The means for receiving the paging message may include the page component 1844 comprised in the communication manager 1832 of the apparatus 1802, which may be configured to perform the aspects described in connection with 1706 and/or 1710 in FIG. 17. The means may include the RX processor 356, the controller/processor 359, the antenna 352, and/or the transmitter 354RX. The apparatus 1802 may include means for transmitting the paging message from the second UE to the first UE over sidelink. In some examples, the means may include the relay component 1850 of the communication manager 1832 and/or the transmission component 1834 of the cellular baseband processor 1804, which may be configured to perform the aspects described in connection with 1714 in FIG. 17. In some examples the means for transmitting the paging message may include the cellular RF transceiver 1822, the TX processor 368, the controller/processor 359, the antenna 352, and/or the transmitter 354TX. The apparatus 1802 may include means for monitoring paging occasions on an access link. The means for monitoring may include the paging occasion component 1842 of the communication manager 1832. The apparatus 1802 may include means for establishing an association with the first UE, which may include the association component 1840 of the communication manager 1832 of the apparatus 1802, and/or the cellular RF transceiver 1822. The apparatus 1802 may include means for determining that the first UE is identified in the paging record list, e.g., the target UE component 1848 of the communication manager 1832 of the apparatus, which may be configured to perform the aspects described in connection with 1712 in FIG. 17. The apparatus 1802 may include means for receiving a prior paging message for the second UE. The means for receiving the paging message may include the page component 1844 comprised in the communication manager 1832 of the apparatus 1802, which may be configured to perform the aspects described in connection with 1706 and/or 1710 in FIG. 17. The means may include the RX processor 356, the controller/processor 359, the antenna 352, and/or the transmitter 354RX. The apparatus 1802 may include means for transitioning to an RRC connected state in response to receiving the prior paging message, e.g., RRC component 1846 of the communication manager 1832, which may be configured to perform the aspects described in connection with 1708 in FIG. 17. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

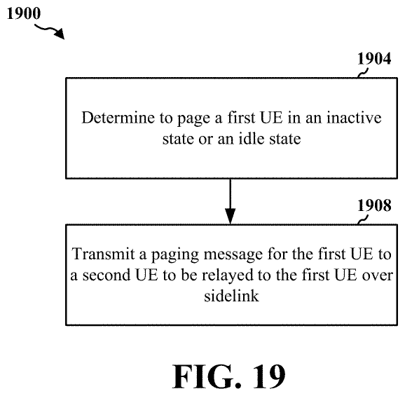

FIG. 19 is a flowchart 1900 of a method of wireless communication. In some examples, the method may be performed by a base station (e.g., the base station 102, 180, 802, 812, 1006, 1106, 1406; the apparatus 2102). The method may help to extend coverage of the base station, reduce latency in communication, improve reliability, and improve the efficient use of wireless resource through relaying a page from a base station to a first UE over sidelink.

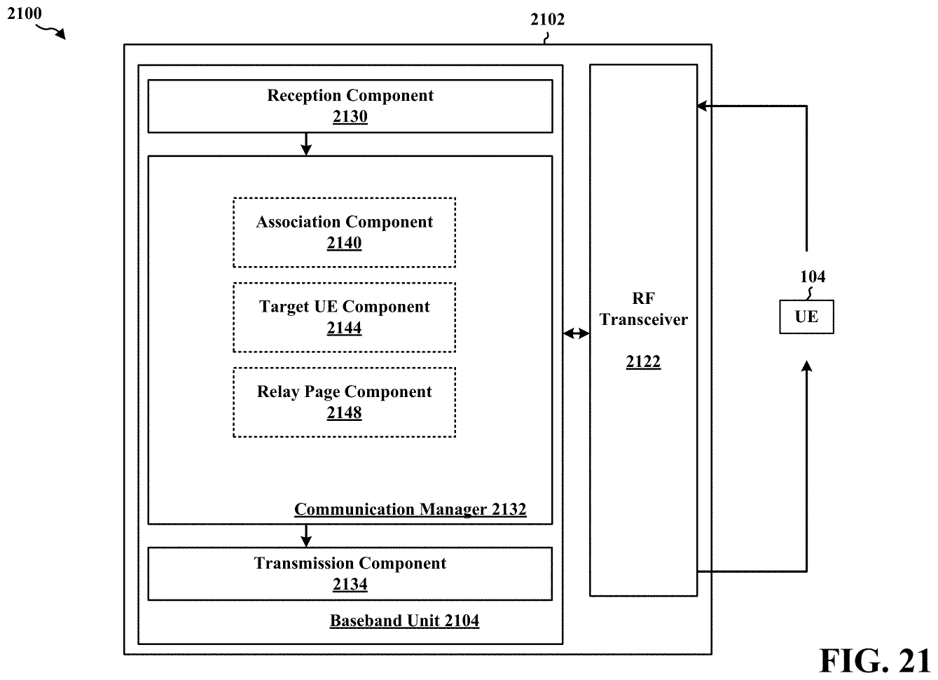

At 1904, the base station determines to page a first UE in an inactive state or an idle state. The base station may receive data to be transmitted to the first UE. The base station may have an update in system information to provide to the first UE that triggers the base station to page the first UE. The base station may have a public warning system message to provide to the first UE. In some aspects, the base station may page the first UE based on incoming data for the first UE. The determination may be performed, e.g., by the target UE component 2144 of the apparatus 2102 in FIG. 21.

At 1908, the base station transmits a paging message for the first UE to a second UE that is in an RRC idle or RRC inactive state, the paging message to be relayed to the first UE over sidelink. The transmission may be performed, e.g., by the transmission component 2134 and/or the page component 2148 of the apparatus 2102 in FIG. 21. The paging message may be transmitted to the second UE over an access link with the base station. The paging message may originate from one of: an AMF for the first UE in an RRC idle state; a serving base station of the first UE that is in an RRC inactive state, or the base station, such as described in connection with FIG. 8.

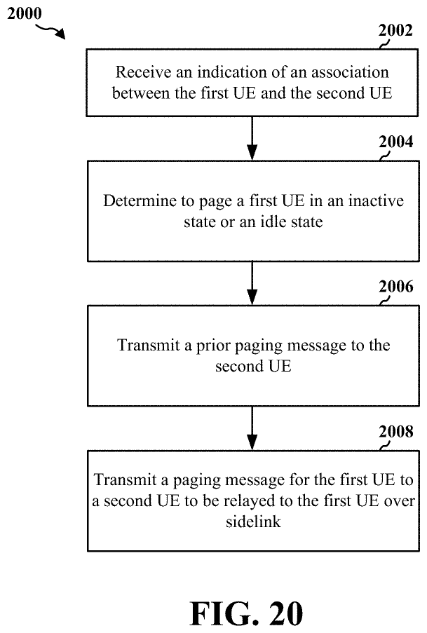

FIG. 20 is a flowchart 2000 of a method of wireless communication. In some examples, the method may be performed by a base station (e.g., the base station 102, 180, 802, 812, 1006, 1106, 1406; the apparatus 2102). The method may help to extend coverage of the base station, reduce latency in communication, improve reliability, and improve the efficient use of wireless resource through relaying a page from a base station to a first UE over sidelink.

At 2004, the base station determines to page a first UE in an inactive state or an idle state. The base station may receive data to be transmitted to the first UE. The base station may have an update in system information to provide to the first UE. The base station may have a public warning system message to provide to the first UE. The determination may be performed, e.g., by the target UE component 2144 of the apparatus 2102 in FIG. 21.

At 2008, the base station transmits a paging message for the first UE to a second UE to be relayed to the first UE over sidelink. The transmission may be performed, e.g., by the transmission component 2134 and/or the page component 2148 of the apparatus 2102 in FIG. 21. The paging message may be transmitted to the second UE over an access link with the base station. The paging message may originate from one of: an AMF for the first UE in an RRC idle state; a serving base station of the first UE that is in an RRC inactive state, or the base station, such as described in connection with FIG. 8. In some examples, the second UE may be in an RRC connected state. In some examples, the second UE may be in an RRC idle state or an RRC inactive state. Transmitting the paging message may include transmitting DCI to the second UE that is in the idle state or the inactive state and transmitting a PDSCH message using resources indicated in the DCI, where the paging message for the first UE is transmitted in the PDSCH message. The PDSCH message may include a first identifier for the second UE, a second identifier for the first UE, and a paging type. The paging message may be transmitted while the second UE remains in the idle state or the inactive state. The base station may scramble the CRC bits of the DCI with a R-RNTI. The base station may scramble the CRC bits of the DCI with a P-RNTI and/or may include bits comprising an indication for a relay request.

The base station may transmit the paging message for the first UE to the second UE during a paging occasion for the first UE. In another example, the paging message may be transmitted in the paging occasion for the first UE that is monitored by the second UE, such as described in connection with FIG. 10.

As illustrated at 2002, the base station may receive an indication of an association between the first UE and the second UE prior to transmitting the paging message. The reception may be performed by the reception component 2130 and/or the association component 2140 of the apparatus 2102 in FIG. 21, for example.

The paging message that is transmitted to the second UE may include a paging record list that identifies the first UE. The paging record list may indicate multiple first UE s, such as described in connection with the examples any of FIG. 12, 13, or 15.

As illustrated at 2006, the base station may transmit a prior paging message to the second UE, the prior paging message being transmitted in a paging occasion for the second UE. The transmission may be performed, e.g., by the transmission component 2134 and/or the page component 2148 of the apparatus 2102 in FIG. 21. The paging message for the first UE may be transmitted, at 2008, in at least one additional message after the second UE transitions to an RRC connected state. FIG. 11 illustrates an example, of the base station transmitting a page to the second UE and transmitting an additional message 1113 with the paging message for the first UE. The at least one additional message may comprise DCI and a PDSCH message that identifies the first UE and a paging type. The DCI may comprise an indication for a relay request. The PDSCH message may comprise an indication for a relay request. A MAC-CE may include the paging information for the first UE. The DCI may include CRC bits that are scrambled with a C-RNTI for the second UE. For example, the base station may further scramble the CRC bits of the DCI with the C-RNTI for the second UE, and the PDSCH message may further include a list of items, each item indicating a paging relay task for a target UE, and wherein each item comprises an identifier for the target UE and a paging type. The CRC bits of the DCI may be scrambled with a PR-RNTI and the PDSCH message may further include a list of items, each item including an identifier for a relay UE, an identifier for the target UE and a paging type. The base station may scramble the CRC bits of the DCI with the PR-RNTI.

FIG. 21 is a diagram 2100 illustrating an example of a hardware implementation for an apparatus 2102. The apparatus 2102 may be a base station, a component of a base station, or may implement base station functionality. The apparatus 2102 may include a baseband unit 2104 or an RF transceiver 2122. The apparatus 2102 may include at least one antenna coupled to the RF transceiver. The baseband unit 2104 may communicate through a cellular RF transceiver with the UE 104. The baseband unit 2104 may include a computer-readable medium/memory. The baseband unit 2104 is responsible for general processing, including the execution of software stored on the computer-readable medium/memory. The software, when executed by the baseband unit 2104, causes the baseband unit 2104 to perform the various functions described supra. The computer-readable medium/memory may also be used for storing data that is manipulated by the baseband unit 2104 when executing software. The baseband unit 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the baseband unit 2104. The baseband unit 2104 may be a component of the device 310 and may include the memory 376 and/or at least one of the TX processor 316, the RX processor 370, and the controller/processor 375.

The communication manager 2132 includes an association component 2140 that receives an indication of an association between the first UE and the second UE prior to transmitting the paging message, e.g., as described in connection with 2002 in FIG. 20. The communication manager 2132 further includes a target UE component 2144 that determines to page a first UE in an inactive state or an idle state, e.g., as described in connection with 2004 in FIG. 20. The communication manager 2132 further includes a page component 2148 that transmits a paging message for the first UE to a second UE to be relayed to the first UE over sidelink and/or transmits transmit a prior paging message to the second UE, e.g., as described in connection with 2006 and/or 2008 in FIG. 20.

The apparatus may include additional components that perform each of the blocks of the algorithm in the flowchart of FIG. 20 of any of the aspects performed by the base station in FIG. 10, 11, or 14. As such, each block in the flowchart of FIG. 20 of any of the aspects performed by the base station in FIG. 10, 11, or 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2102, and in particular the baseband unit 2104, includes means for determining to page UE in an inactive state or an idle state. The means may include the target UE component 2144 comprised in the communication manager of the apparatus 2102, which may be configured to perform the aspects described in connection with 2004 in FIG. 20. In some examples, the means for determining to page the UE may include a determination circuit. The apparatus includes means for transmitting a paging message for the first UE to a second UE to be relayed to the first UE over sidelink. In some examples, the means may include the transmission component 2134 of the baseband unit 2104 in the apparatus 2102 in FIG. 21, which may be configured to perform the aspects described in connection with 2008 in FIG. 20. In some examples the means for transmitting the paging message may include the TX processor 316, the controller/processor 375, the antenna 320, and/or the transmitter 318TX. The apparatus may include means for receiving an indication of an association between the first UE and the second UE prior to transmitting the paging message, which may include the association component 2140 comprised in the communication manager of the apparatus 2102, which may be configured to perform the aspects described in connection with 2002 in FIG. 20. The means may include the RX processor 370, the controller/processor 375, the antenna 320, and/or the transmitter 318RX. The apparatus may include means for transmitting a prior paging message to the second UE. In some examples, the means may include the transmission component 2134 of the baseband unit 2104 in the apparatus 2102 in FIG. 21, which may be configured to perform the aspects described in connection with 2006 in FIG. 20. In some examples the means for transmitting the paging message may include the TX processor 316, the controller/processor 375, the antenna 320, and/or the transmitter 318TX. The means may be one or more of the components of the apparatus 2102 configured to perform the functions recited by the means. As described supra, the apparatus 2102 may include the TX Processor 316, the RX Processor 370, and the controller/processor 375. As such, in one configuration, the means may be the TX Processor 316, the RX Processor 370, and the controller/processor 375 configured to perform the functions recited by the means.

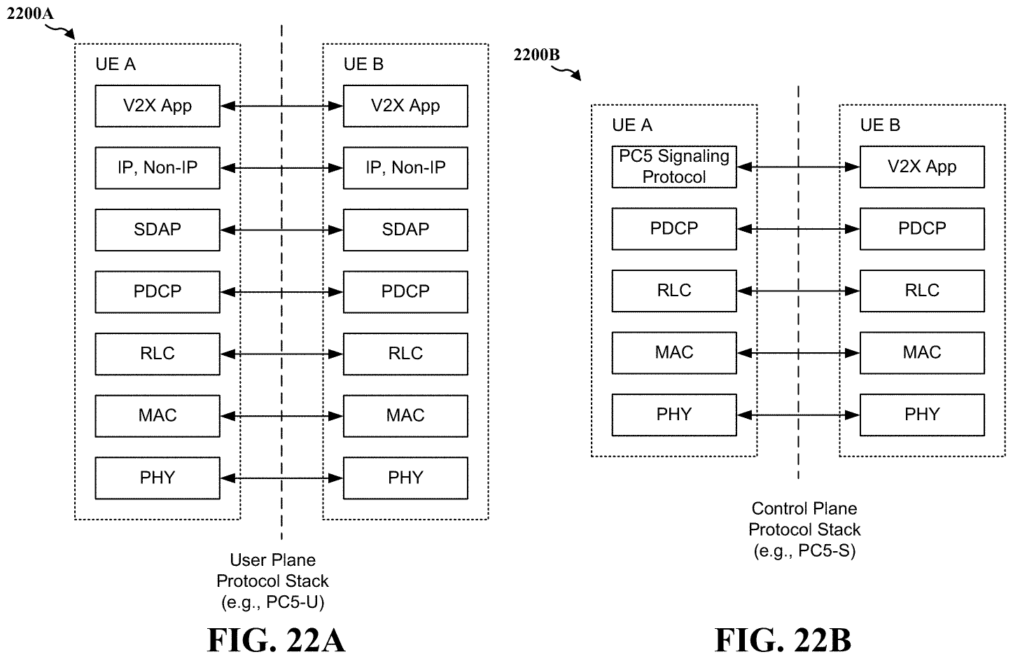

To establish a communication over sidelink, a user-level protocol stack may be used for exchanging user data and a control level protocol stack may be defined for exchanging control messages. FIG. 22A is a diagram 2200A illustrating an example of a user plane protocol stack for a sidelink communication. In some examples, the user plane protocol stack may correspond to a user plane for a PC5 reference point (e.g., PC5-U) supporting V2X services, as an example of sidelink communication, for a first UE (UE A) and a second UE (UE B). IP and Non-IP Packet Data Convergence Protocol (PDCP) Service Data Unit (SDU) types may be supported for the sidelink communication. FIG. 22B is a diagram 2200B illustrating an example of a signaling protocol stack for a sidelink communication. In some examples, the signaling protocol stack may correspond to a control plane for a PC5 reference point (e.g., PC5-S) for the first UE (UE A) and the second UE (UE B). In some examples, sidelink messages may be carried in RRC signaling. The physical (PHY) layer may transmit sidelink data (e.g., using 10 MHz, 20 MHz, or other bandwidths, etc.). The MAC layer may manage packet flow control and resource allocation. The radio link control (RLC) layer may enable upper layer Protocol Data Units (PDUs) to be transferred in various modes (e.g., Acknowledged Mode, Unacknowledged Mode and Transparent Mode, etc.), and the RLC layer may also ensure proper concatenation, segmentation and reassembly for RLC SDUs.

In some examples, a sidelink message (e.g., a message transmitted via sidelink 716) may include a Layer-2 identifier (L2 ID) for sidelink communication over the PC5 reference point. For example, each UE may have one or more L2 IDs for sidelink communication. The L2 ID may include one or more source L2 IDs and/or one or more destination L2 IDs. The source and/or destination L2 IDs may be included in Layer-2 frames that are sent on a Layer-2 link from the relay UE to the target UE. In one configuration, the source L2 IDs may be self-assigned by the UE originating the corresponding Layer-2 frames.

In some examples, the destination L2 ID may be mapped to a sidelink (e.g., V2X) service type of the sidelink application for broadcast. In some examples, the destination L2 ID may be mapped to a sidelink (e.g., V2X) service type of the sidelink application for groupcast. A default destination L2 ID may be mapped for initial signaling to establish a unicast connection and the service type of the sidelink application. The sets of mapping information may be provisioned to the UE.

In some examples, the selection of the destination L2 ID may depend on the type of sidelink communication, e.g., whether the sidelink communication is unicast, broadcast, or groupcast, etc. For example, the destination L2 ID for broadcast sidelink communication may be selected based on a mapping between the service type (e.g., a PSID/ITS-AID) and a L2 ID. For groupcast sidelink communication, group identifier information may be provided by the application layer (e.g., V2X application layer), and the UE may convert the provided group identifier into a destination L2 ID. Otherwise, if the group identifier information is not provided, the UE may determine the L2 ID based on a mapping between the service type (e.g., a provider service identifier (PSID)/intelligent transportation system application identifier (ITS-AID)) and a L2 ID. For unicast sidelink communication, the initial signaling for the establishment of a unicast link (e.g. a PC5 unicast link) may use a known L2 ID of the communication peer, or a default destination L2 ID associated with the sidelink service type (e.g. PSID/ITS-AID) configured for a unicast link establishment. During the unicast link establishment procedure, L2 IDs may be exchanged between two UEs, and may be used for future communication between the two UEs. A UE may establish multiple unicast links with a peer UE and use the same or different source L2 IDs for these unicast links. For example, a relay UE (e.g., 702) may relay paging information to the target UE (e.g., 708) over sidelink (e.g., 716) using a L2 ID based on the type of communication (e.g., unicast, broadcast, or groupcast) and/or based on any of these additional aspects.

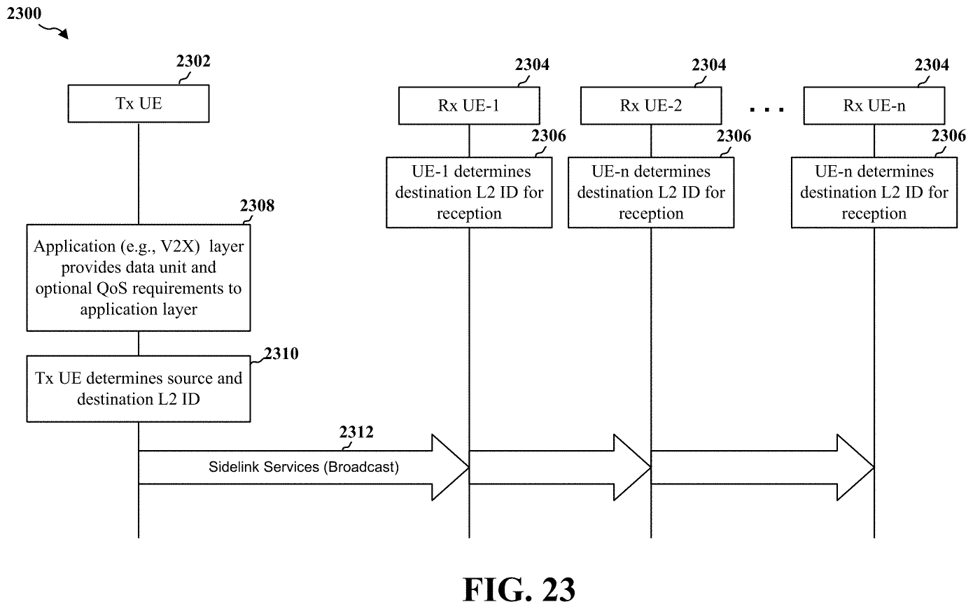

FIG. 23 is a diagram 2300 illustrating an example of the broadcast procedure over sidelink from a transmitting UE 2302 (e.g., Tx UE) to one or more (e.g., n) receiving UE(s) 2304 (e.g., Rx UE-1, Rx UE-2 . . . Rx UE-n). At 2306, the receiving UE(s) 2304 may determine the destination L2 ID for broadcast reception. At 2308, the transmitting UE 2102's sidelink (e.g., V2X) application layer may provide the data unit for the transmitting UE 2302. Then at 2310, transmitting UE 2302 may determine the destination L2 ID for broadcast. At 2312, the transmitting UE 2302 may send (e.g., broadcast) the sidelink service data (e.g., V2X service data) using the source L2 ID and the destination L2 ID.

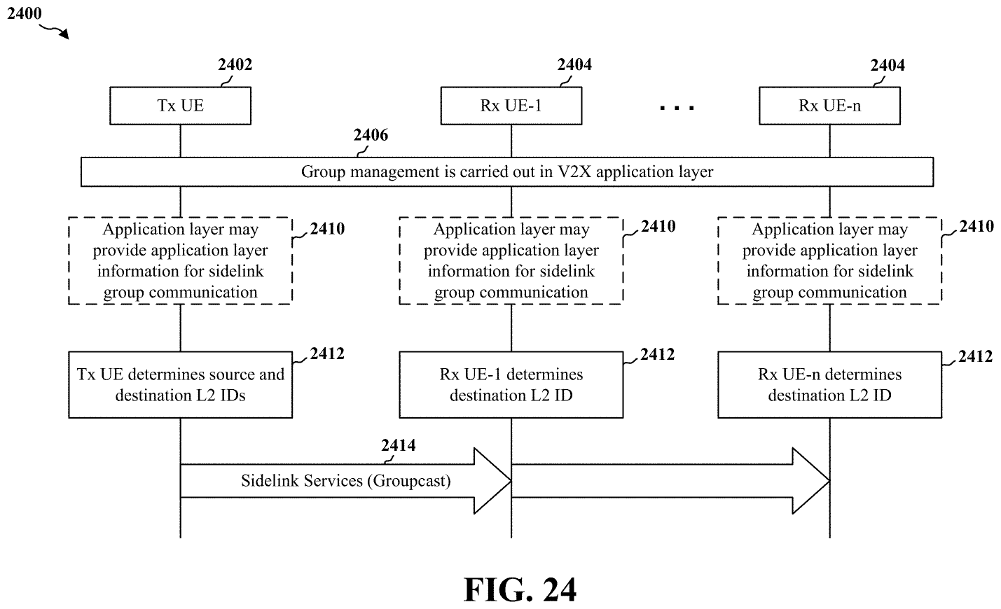

FIG. 24 is a diagram 2400 illustrating an example of the groupcast procedure over sidelink. At 2406, a sidelink (e.g., V2X) group management may be carried out by the application layer at the transmitting UE 2402 and one or more (e.g., n) receiving UE(s) 2404. At 2410, the application layer may provide a group identifier information (e.g., an Application-layer V2X Group identifier) to the transmitting UE 2402 and/or the receiving UE(s) 2404. At 2412, the transmitting UE 2402 may determine a source L2 ID and a destination L2 ID, and the receiving UE(s) 2404 may determine a destination L2 ID. Then at 2414, the transmitting UE 2402 may send the sidelink service data (e.g., in groupcast) using the source L2 ID and the destination L2 ID.

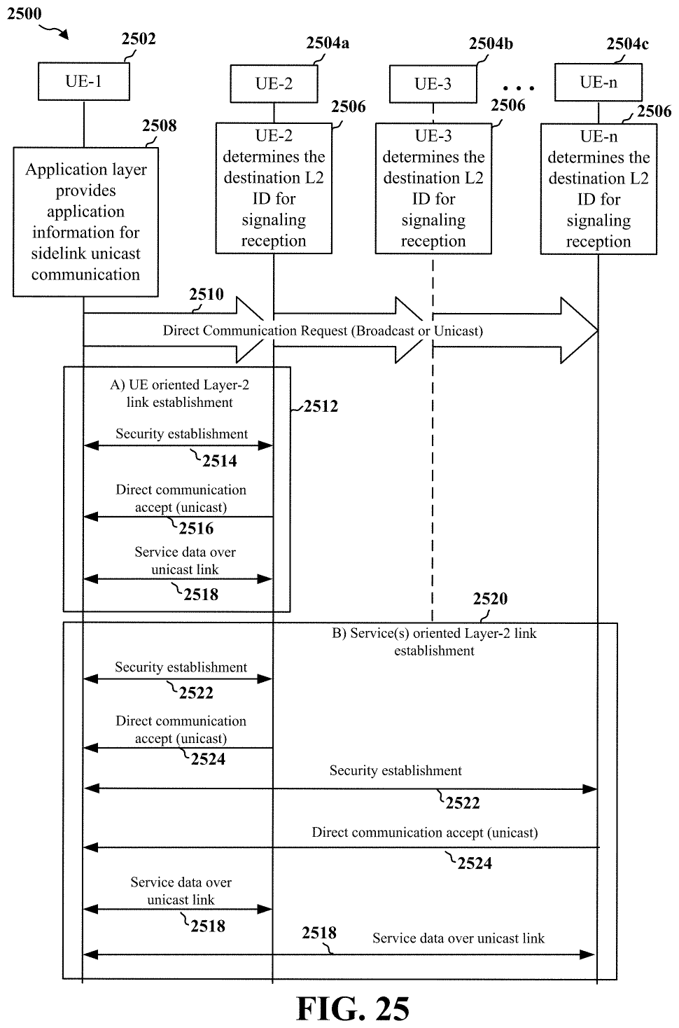

FIG. 25 is a diagram 2500 illustrating an example of the unicast procedure over the sidelink. At 2506, one or more UEs (e.g., UE-2 2504a, UE-3 2504b, UE-n 2504c, etc.) may determine the destination L2 ID for a unicast link establishment (e.g., a PC5 unicast link establishment). At 2508, the sidelink (e.g., V2X) application layer in UE-1 2502 may provide application information for the sidelink unicast communication. Then, at 2510, the UE-1 2502 may send a direct communication request message (e.g., in groupcast or unicast) to the one or more UEs to initiate the unicast Layer-2 link establishment procedure. The UE-1 2502 may established the security with the one or more UEs based on at least one of the following ways. In one configuration, if a target user information (e.g., Target User Info) is included in the direct communication request transmitted from the UE-1 2502 (e.g., at 2510), such as for a UE oriented Layer-2 link establishment 2512, then at 2514, the target UE (e.g., UE-2 2504a) may respond to the direct communication request message by establishing the security with the UE-1 2502. If the target user information is not included in the direct communication request message (e.g., no specified target user), such as for a sidelink (e.g., V2X) service(s) oriented Layer-2 link establishment 2520, then at 2522, UEs (e.g., UE-2 2504a, UE-n 2504c) that are interested in using the announced sidelink service(s) (e.g., V2X Services) over a sidelink unicast link with the UE-1 2502 may respond to the direct communication request message by establishing the security with the UE-1 2502.

After the security is established (e.g., at 2514 or 2522), a direct communication accept message may be sent to UE-1 2502 by the target UE (e.g., UE-2 2504a) for the UE oriented Layer-2 link establishment 2512 or by the UEs (e.g., UE-2 2504a and/or UE-n 2504c) that are interested in using the announced sidelink service(s) for the sidelink service(s) oriented Layer-2 link establishment 2520. For example, at 2516, the target UE-2 2504a may respond to the UE-1 2502 with a direct communication accept message if the Application Layer ID for the UE-2 2504a matches. Similarly, UEs (e.g., UE-2 2504a and/or UE-n 2504c) that are interested in using the announced sidelink service(s) may respond to the direct communication request by sending a direct communication accept message, such as shown at 2524. After the direct communication is established between the UE-1 2502 and the one or more UEs, at 2518, the UE-1 2502 may sends sideline service data based on the source L2 ID and the destination L2 ID to the one or more UEs (e.g., UE-2 2504a and/or UE-n 2504c) that have accepted the direct communication.

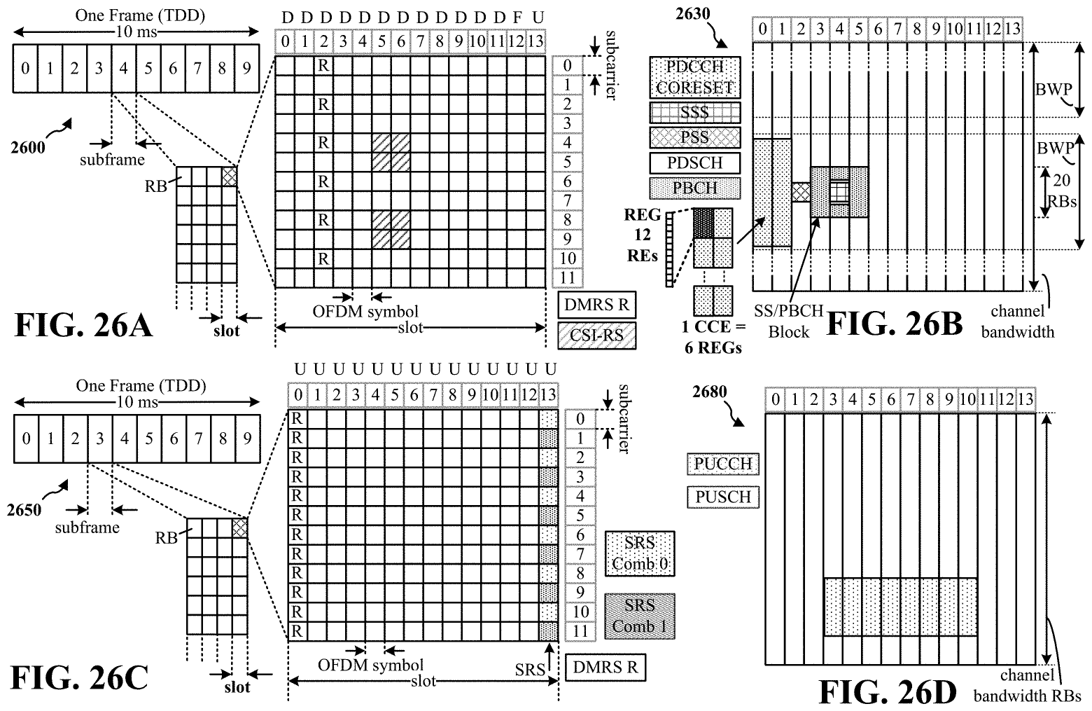

FIGS. 26A-26D illustrate an example frame structure 2600, e.g., that may be used for an access link between a UE and a base station. The aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 26A-26D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 26B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 26A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 26B illustrates an example 2630 of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in the example resources 2650 of FIG. 26C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 26D illustrates an example 2680 of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

The following examples are illustrative only and aspects thereof may be combined with aspects of other embodiments or teaching described herein, without limitation.

Aspect 1 is method of wireless communication at a first UE, comprising: receiving a paging message for a second UE from a base station; and transmitting the paging message from the first UE to the second UE over sidelink.

In aspect 2, the method of aspect 1 further includes that the paging message for the second UE is received by the first UE from the base station over an access link with the base station.

In aspect 3, the method of aspect 1 or 2 further includes that the first UE in an RRC idle state or an RRC inactive state, the method further comprising: monitoring paging occasions on an access link, wherein the paging message for the second UE is received by the first UE during a paging occasion.

In aspect 4, the method of any of aspects 1-3 further includes that the paging occasions comprise a first set of paging occasions for the second UE.

In aspect 5, the method of any of aspects 1-4 further includes that the paging occasions further comprise a second set of paging occasions for the first UE.

In aspect 6, the method of any of aspects 1-5 further includes establishing an association with the second UE, wherein the first UE monitors the first set of paging occasions for the second UE based on the association.

In aspect 7, the method of any of aspects 1-6 further includes that the paging message is received in the paging occasion for the second UE that is monitored by the first UE.

In aspect 8, the method of any of aspects 1-7 further includes that the paging message that is received by the first UE from the base station includes a paging record list, the method further comprising: determining that the second UE is identified in the paging record list, wherein the first UE transmits the paging message to the second UE in response to determining that the second UE is identified in the paging record list.

In aspect 9, the method of any of aspects 1-8 further includes that the paging message that is received from the base station includes a paging record list, and the first UE transmits the paging message comprising the paging record list to the second UE.

In aspect 10, the method of any of aspects 1-9 further includes receiving a prior paging message for the first UE, the prior paging message being received in a paging occasion for the first UE; and transitioning to an RRC connected state in response to receiving the prior paging message, wherein the paging message for the second UE is received in at least one additional message while the first UE is in the RRC connected state.

In aspect 11, the method of any of aspects 1-10 further includes that the at least one additional message comprises DCI and a PDSCH message that identifies the second UE and a paging type.

In aspect 12, the method of any of aspects 1-11 further includes that the DCI comprises an indication for a relay request, and wherein the first UE transitions to the RRC connected state in response to the indication for the relay request.

In aspect 13, the method of any of aspects 1-12 further includes that the PDSCH message comprises an indication for a relay request, and wherein the first UE transitions to the RRC connected state in response to the indication for the relay request.

In aspect 14, the method of any of aspects 1-13 further includes that a MAC-CE includes paging information for the second UE, and wherein the first UE transitions to the RRC connected state in response to receiving the paging information.

In aspect 15, the method of any of aspects 1-14 further includes that CRC bits of the DCI are scrambled with a C-RNTI for the first UE, and the PDSCH message further includes a list of items, each item indicating a paging relay task for the second UE, and wherein each item comprises an identifier for the second UE and the paging type.

In aspect 16, the method of any of aspects 1-15 further includes that CRC bits of the DCI are scrambled with a PR-RNTI and the PDSCH message further includes a list of items, and wherein each item includes a first identifier for the first UE, a second identifier for the second UE, and the paging type.

In aspect 17, the method of any of aspects 1-16 further includes receiving DCI while in an idle state or an inactive state; and determining resources for a PDSCH message from the DCI, wherein the paging message for the second UE is received in the PDSCH message.

In aspect 18, the method of any of aspects 1-17 further includes that the PDSCH message includes a first identifier for the first UE, a second identifier for the second UE, and a paging type.

In aspect 19, the method of any of aspects 1-18 further includes that the first UE remains in the idle state or the inactive state.

In aspect 20, the method of any of aspects 1-19 further includes determining to relay the paging message to the second UE based on CRC bits of DCI being scrambled with a R-RNTI.

In aspect 21, the method of any of aspects 1-20 further includes determining to relay the paging message to the second UE based on CRC bits of the DCI being scrambled with a P-RNTI and includes bits comprising an indication for a relay request.

Aspect 22 is a device including one or more processors and one or more memories in electronic communication with the one or more processors storing instructions executable by the one or more processors to cause the device to implement a method as in any of aspects 1-21.

Aspect 23 is a system or apparatus including means for implementing a method or realizing an apparatus as in any of aspects 1-21.

Aspect 24 is a non-transitory computer readable storage medium storing instructions executable by one or more processors to cause the one or more processors to implement a method as in any of aspects 1-21.

Aspect 25 is a method of wireless communication at a base station, comprising:

determining to page a first UE in an inactive state or an idle state; and transmitting a paging message for the first UE to a second UE to be relayed to the first UE over sidelink.

In aspect 26, the method of aspect 25 further includes that the paging message is transmitted to the second UE over an access link with the base station.

In aspect 27, the method of aspect 25 or aspect 26 further includes that the second UE is in an RRC idle state or an RRC inactive state and the base station transmits the paging message for the first UE to the second UE during a paging occasion for the first UE.

In aspect 28, the method of any of aspects 25-27 further includes receiving an indication of an association between the first UE and the second UE prior to transmitting the paging message.

In aspect 29, the method of any of aspects 25-28 further includes that the paging message is transmitted in the paging occasion for the first UE that is monitored by the second UE.

In aspect 30, the method of any of aspects 25-29 further includes that the paging message that is transmitted to the second UE includes a paging record list that identifies the first UE.

In aspect 31, the method of any of aspects 25-30 further includes that the paging record list indicates multiple target UEs.

In aspect 32, the method of any of aspects 25-31 further includes transmitting a prior paging message to the second UE, the prior paging message being transmitted in a paging occasion for the second UE, wherein the paging message for the first UE is transmitted in at least one additional message after the second UE transitions to an RRC connected state.

In aspect 33, the method of any of aspects 25-32 further includes that the at least one additional message comprises DCI and a PDSCH message that identifies the first UE and a paging type.

In aspect 34, the method of any of aspects 25-33 further includes that the DCI comprises an indication for a relay request.

In aspect 35, the method of any of aspects 25-34 further includes that the PDSCH message comprises an indication for a relay request.

In aspect 36, the method of any of aspects 25-35 further includes that a MAC-CE includes paging information for the first UE.

In aspect 37, the method of any of aspects 25-36 further includes scrambling CRC bits of the DCI with a C-RNTI for the second UE, and the PDSCH message further includes a list of items, each item indicating a paging relay task for the first UE, and wherein each item comprises an identifier for the first UE and the paging type.

In aspect 38, the method of any of aspects 25-37 further includes scrambling CRC bits of the DCI with a PR-RNTI and the PDSCH message further includes a list of items, wherein each item includes a first identifier for the second UE, a second identifier for the first UE and the paging type.

In aspect 39, the method of any of aspects 25-38 further includes transmitting DCI to the second UE that is in the idle state or the inactive state; and transmitting a PDSCH message using resources indicated in the DCI, wherein the paging message for the first UE is transmitted in the PDSCH message.

In aspect 40, the method of any of aspects 25-39 further includes the PDSCH message includes a first identifier for the second UE, a second identifier for the first UE, and a paging type.

In aspect 41, the method of any of aspects 25-40 further includes the paging message is transmitted while the second UE remains in the idle state or the inactive state.

In aspect 42, the method of any of aspects 25-41 further includes scrambling CRC bits of the DCI with a R-RNTI.

In aspect 43, the method of any of aspects 25-42 further includes scrambling CRC bits of the DCI with a P-RNTI and includes bits comprising an indication for a relay request.

Aspect 44 is a device including one or more processors and one or more memories in electronic communication with the one or more processors storing instructions executable by the one or more processors to cause the device to implement a method as in any of aspects 25-43.

Aspect 45 is a system or apparatus including means for implementing a method or realizing an apparatus as in any of aspects 25-43.

Aspect 46 is a non-transitory computer readable storage medium storing instructions executable by one or more processors to cause the one or more processors to implement a method as in any of aspects 25-43.

Aspect 47 is a method of wireless communication, comprising: receiving, at a second UE, a paging message for a first UE from a base station while in a RRC idle mode or an RRC inactive mode; and transmitting the paging message from the second UE to the first UE over sidelink.

In aspect 48, the method of aspect 47 further includes receiving a prior paging message for the second UE, the prior paging message being received in a paging occasion for the second UE; and transitioning to an RRC connected state in response to a first reception of the prior paging message to receive the paging message in at least one additional message while the second UE is in the RRC connected state.

In aspect 49, the method of aspect 48 further includes that the at least one additional message comprises DCI and a PDSCH message that identifies the first UE and a paging type.

In aspect 50, the method of aspect 49 further includes that the DCI comprises an indication for a relay request, the method further including transitioning the second UE to the RRC connected state in response to the indication for the relay request.

In aspect 51, the method of aspect 49 further includes that the PDSCH message comprises an indication for a relay request, the method further including transitioning the second UE to the RRC connected state in response to the indication for the relay request.

In aspect 52, the method of aspect 49 further includes that a MAC-CE includes paging information for the first UE, the method further including transitioning the second UE to the RRC connected state in response to receiving the paging information.

In aspect 53, the method of aspect 49 further includes that CRC bits of the DCI are scrambled with a C-RNTI for the second UE, and the PDSCH message further includes a list of items, each item indicating a paging relay task for the first UE, and wherein each item comprises an identifier for the first UE and the paging type.

In aspect 54, the method of aspect 49 further includes that CRC bits of the DCI are scrambled with a PR-RNTI and the PDSCH message further includes a list of items, and wherein each item includes a first identifier for the first UE, a second identifier for the second UE, and the paging type.

In aspect 55, the method of any of aspects 47-49 or 53-54 further includes that receiving the paging message includes receiving a DCI while in the RRC idle mode or the RRC inactive mode; determining, from the DCI, resources for a PDSCH message comprising the paging message for the first UE, a first identifier for the first UE, a second identifier for the second UE, and a paging type; and maintaining the second UE in the RRC idle mode or the RRC inactive mode.

In aspect 56, the method of aspect 55 further includes relaying the paging message to the first UE based on CRC bits of the DCI being scrambled with a R-RNTI.

In aspect 57, the method of aspect 55 further includes relaying the paging message to the first UE based on CRC bits of the DCI being scrambled with a P-RNTI and including bits comprising an indication for a relay request.

In aspect 58, the method of any of aspects 47-57 further includes that the paging message for the first UE is from the base station over an access link with the base station.

In aspect 59, the method of any of aspects 47-58 further includes monitoring a first set of paging occasions for the first UE on an access link for the paging message for the first UE.

In aspect 60, the method of any of aspects 47-59 further includes monitoring monitor a second set of paging occasions for the second UE.

In aspect 61, the method of any of aspects 47-60 further includes establishing an association with the first UE, wherein monitoring of the first set of paging occasions for the first UE is based on the association.

In aspect 62, the method of any of aspects 47-61 further includes that the paging message from the base station includes a paging record list, the method including transmitting the paging message to the first UE based on the first UE being identified in the paging record list.

In aspect 63, the method of any of aspects 47-61 further includes that the paging message including a paging record list, the method further including transmitting the paging message comprising the paging record list to the first UE.

Aspect 64 is an apparatus for wireless communication, comprising: a memory; and at least one processor coupled to the memory, the memory and the at least one processor configured to perform the method of any of aspects 47-63.

In aspect 65, the apparatus of aspect 64 further includes at least one antenna and a transceiver coupled to the at least one antenna and the at least one processor.

Aspect 66 is an apparatus for wireless communication, comprising means to perform the method of any of aspects 47-63.

In aspect 67, the apparatus of aspect 66 further includes at least one antenna and a transceiver coupled to the at least one antenna.

Aspect 68 is a non-transitory computer-readable storage medium storing computer executable code, the code when executed by a processor cause the processor to perform the method of any of claims 47-63.

Aspect 69 is a method of wireless communication at a base station, comprising:

determining to page a first UE in an inactive state or an idle state; and transmitting a paging message for the first UE to a second UE in a RRC idle state or an RRC inactive state, the paging message to be relayed to the first UE over sidelink.

In aspect 70, the method of aspect 69 further includes receiving an indication of an association between the first UE and the second UE prior to transmission of the paging message.

In aspect 71, the method of aspect 69 or aspect 70 further includes that the base station transmits the paging message in a paging occasion for the first UE that is monitored by the second UE.

In aspect 72, the method of any of aspects 69-71 further includes that transmitting the paging message includes transmitting DCI to the second UE that is in the RRC idle state or the RRC inactive state; and transmitting a PDSCH message using resources indicated in the DCI, wherein the PDSCH message comprising the paging message for the first UE.

In aspect 73, the method of aspect 72 further includes that the PDSCH message includes a first identifier for the second UE, a second identifier for the first UE, and a paging type.

In aspect 74, the method of aspect 72 or 73 further includes scrambling CRC bits of the DCI with a R-RNTI.

In aspect 75, the method of aspect 72 or 73 further includes scrambling CRC bits of the DCI with a P-RNTI and includes bits comprising an indication for a relay request.

In aspect 76, the method of any of aspects 69-75 further includes that the paging message for transmission to the second UE includes a paging record list that identifies the first UE.

In aspect 77, the method of aspect 76 further includes that the paging record list indicates multiple target UEs.

In aspect 78, the method of any of aspects 69-72, 76, or 77 further includes transmitting a prior paging message to the second UE, the prior paging message being transmitted in a paging occasion for the second UE, wherein the paging message for the first UE is transmitted in at least one additional message after the second UE transitions to an RRC connected state.

In aspect 79, the method of aspect 78 further includes that the at least one additional message comprising a DCI and a PDSCH message that identifies the first UE and a paging type, the method further including scrambling CRC bits of the DCI with a C-RNTI for the second UE or a PR-RNTI, and the PDSCH message further includes a list of items, each item indicating a paging relay task for the first UE, and wherein each item comprises an identifier for the first UE and the paging type.

Aspect 80 is an apparatus for wireless communication, comprising: a memory; and at least one processor coupled to the memory, the memory and the at least one processor configured to perform the method of any of aspects 69-79.

In aspect 81, the apparatus of aspect 80 further includes at least one antenna and a transceiver coupled to the at least one antenna and the at least one processor.

Aspect 82 is an apparatus for wireless communication, comprising means to perform the method of any of aspects 69-79.

In aspect 83, the apparatus of aspect 82 further includes at least one antenna and a transceiver coupled to the at least one antenna.

Aspect 84 is a non-transitory computer-readable storage medium storing computer executable code, the code when executed by a processor cause the processor to perform the method of any of claims 69-79.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory, the memory and the at least one processor configured to:
receive, at a second user equipment (UE), a paging message for a first UE from a base station while in a radio resource control (RRC) idle mode or an RRC inactive mode; and
transmit the paging message from the second UE to the first UE over sidelink.

2. The apparatus of claim 1, the memory and the at least one processor being further configured to:
receive a prior paging message for the second UE, the prior paging message being received in a paging occasion for the second UE; and
transition to an RRC connected state in response to a first reception of the prior paging message to receive the paging message in at least one additional message while the second UE is in the RRC connected state.

3. The apparatus of claim 2, the at least one additional message comprising downlink control information (DCI) and a physical downlink shared channel (PDSCH) message that identifies the first UE and a paging type.

4. The apparatus of claim 3, the DCI comprising an indication for a relay request, and the memory and the at least one processor are configured to transition the second UE to the RRC connected state in response to the indication for the relay request.

5. The apparatus of claim 3, the PDSCH message comprising an indication for a relay request, and the memory and the at least one processor are configured to transition the second UE to the RRC connected state in response to the indication for the relay request.

6. The apparatus of claim 3, wherein a medium access control-control element (MAC-CE) includes paging information for the first UE, and the memory and the at least one processor are configured to transition the second UE to the RRC connected state in response to receiving the paging information.

7. The apparatus of claim 3, wherein cyclic redundancy check (CRC) bits of the DCI are scrambled with a cell radio network temporary identifier (C-RNTI) for the second UE, and the PDSCH message further includes a list of items, each item indicating a paging relay task for the first UE, and wherein each item comprises an identifier for the first UE and the paging type.

8. The apparatus of claim 3, wherein cyclic redundancy check (CRC) bits of the DCI are scrambled with a paging relay radio network temporary identifier (PR-RNTI) and the PDSCH message further includes a list of items, and wherein each item includes a first identifier for the first UE, a second identifier for the second UE, and the paging type.

9. The apparatus of claim 1, wherein to receive the paging message, the memory and the at least one processor are further configured to:
receive a downlink control information (DCI) while in the RRC idle mode or the RRC inactive mode;
determine, from the DCI, resources for a physical downlink shared channel (PDSCH) message comprising the paging message for the first UE, a first identifier for the first UE, a second identifier for the second UE, and a paging type; and
maintain the second UE in the RRC idle mode or the RRC inactive mode.

10. The apparatus of claim 9, the memory and the at least one processor being further configured to:
relay the paging message to the first UE based on cyclic redundancy check (CRC) bits of the DCI being scrambled with a relay radio network temporary identifier (R-RNTI).

11. The apparatus of claim 9, the memory and the at least one processor being further configured to:
relay the paging message to the first UE based on cyclic redundancy check (CRC) bits of the DCI being scrambled with a paging radio network temporary identifier (P-RNTI) and including bits comprising an indication for a relay request.

12. The apparatus of claim 1, the paging message for the first UE being from the base station over an access link with the base station.

13. The apparatus of claim 1, the memory and the at least one processor being further configured to:
monitor a first set of paging occasions for the first UE on an access link for the paging message for the first UE.

14. The apparatus of claim 13, the memory and the at least one processor being further configured to:
monitor a second set of paging occasions for the second UE.

15. The apparatus of claim 13, the memory and the at least one processor being further configured to:
establish an association with the first UE, wherein monitoring of the first set of paging occasions for the first UE is based on the association.

16. The apparatus of claim 1, wherein the paging message from the base station includes a paging record list, the memory and the at least one processor being further configured to:
transmit the paging message to the first UE based on the first UE being identified in the paging record list.

17. The apparatus of claim 1, the paging message including a paging record list, and the memory and the at least one processor being configured to transmit the paging message comprising the paging record list to the first UE.

18. A method of wireless communication, comprising:
receiving, at a second user equipment (UE), a paging message for a first UE from a base station while in a radio resource control (RRC) idle mode or an RRC inactive mode; and
transmitting the paging message from the second UE to the first UE over sidelink.

19. An apparatus for wireless communication at a base station, comprising:
a memory; and
at least one processor coupled to the memory, the memory and the at least one processor configured to:
determine to page a first user equipment (UE) in an inactive state or an idle state; and
transmit a paging message for the first UE to a second UE in a radio resource control (RRC) idle state or an RRC inactive state, the paging message to be relayed to the first UE over sidelink.

20. The apparatus of claim 19, the memory and the at least one processor being further configured to:
receive an indication of an association between the first UE and the second UE prior to transmission of the paging message.

21. The apparatus of claim 19, the memory and the at least one processor being configured to transmit the paging message in a paging occasion for the first UE that is monitored by the second UE.

22. The apparatus of claim 19, wherein to transmit the paging message, the memory and the at least one processor are configured to:
transmit downlink control information (DCI) to the second UE that is in the RRC idle state or the RRC inactive state; and
transmit a physical downlink shared channel (PDSCH) message using resources indicated in the DCI, wherein the PDSCH message comprising the paging message for the first UE.

23. The apparatus of claim 22, the PDSCH message including a first identifier for the second UE, a second identifier for the first UE, and a paging type.

24. The apparatus of claim 22, the memory and the at least one processor being further configured to:
scramble cyclic redundancy check (CRC) bits of the DCI with a relay radio network temporary identifier (R-RNTI).

25. The apparatus of claim 22, the memory and the at least one processor being further configured to:
scramble cyclic redundancy check (CRC) bits of the DCI with a paging radio network temporary identifier (P-RNTI) and includes bits comprising an indication for a relay request.

26. The apparatus of claim 19, the paging message for transmission to the second UE including a paging record list that identifies the first UE.

27. The apparatus of claim 26, the paging record list indicating multiple target UEs.

28. The apparatus of claim 19, the memory and the at least one processor being further configured to:
transmit a prior paging message to the second UE, the prior paging message being transmitted in a paging occasion for the second UE, wherein the paging message for the first UE is transmitted in at least one additional message after the second UE transitions to an RRC connected state.

29. The apparatus of claim 28, the at least one additional message comprising a downlink control information (DCI) and a physical downlink shared channel (PDSCH) message that identifies the first UE and a paging type, the memory and the at least one processor being further configured to:
scramble cyclic redundancy check (CRC) bits of the DCI with a cell radio network temporary identifier (C-RNTI) for the second UE or a paging relay radio network temporary identifier (PR-RNTI), and the PDSCH message further includes a list of items, each item indicating a paging relay task for the first UE, and wherein each item comprises an identifier for the first UE and the paging type.

30. A method of wireless communication at a base station, comprising:
determining to page a first user equipment (UE) in an inactive state or an idle state; and
transmitting a paging message for the first UE to a second UE in a radio resource control (RRC) idle state or an RRC inactive state, the paging message to be relayed to the first UE over sidelink.
